(19) United States
(12) Patent Application Publication
(10) Pub. No.: US 2025/0348895 A1
(43) Pub. Date: Nov. 13, 2025

(54) METHODS AND APPARATUS TO REDUCE SIGNAL-TO-NOISE RATIO (SNR) OF MONADIC SCORES

(71) Applicant: Nielsen Consumer LLC, Chicago, IL (US)

(72) Inventors: Kamal M. Malek, Weston, MA (US); Ali Kebarighotbi, Needham, MA (US); David B. Teller, Sudbury, MA (US)

(21) Appl. No.: 19/219,759

(22) Filed: May 27, 2025

Related U.S. Application Data
(63) Continuation of application No. 17/693,039, filed on Mar. 11, 2022.
(60) Provisional application No. 63/160,417, filed on Mar. 12, 2021.

(51) Int. Cl. G06Q 30/0201; G06N 7/01; G06Q 30/0203

(52) U.S. Cl. CPC G06Q 30/0201; G06N 7/01; G06Q 30/0203

(57) ABSTRACT

Methods and apparatus disclosed herein reduce signal-to-noise ratio (SNR) of monadic scores. An example apparatus to reduce a signal-to-noise ratio (SNR) of monadic scores, the apparatus includes memory, machine readable instructions, and processor circuitry to execute the machine readable instructions to at least identify a discrete choice probability of selection corresponding to a first product, generate a scale question corresponding to the first product, calculate a monadic probability corresponding to the first product based on the scale question for the first product, and reduce the SNR of the monadic probability by joining the discrete choice probability of selection of the first product with the monadic probability of selecting the first product.

### FIELD OF THE DISCLOSURE

This disclosure relates generally to computing systems, and, more particularly, to methods and apparatus to reduce signal-to-noise ratio (SNR) of monadic scores.

### BACKGROUND

Concept testing includes survey-based research assessing customer willingness to buy certain product(s) of interest prior to the release of the given product(s). Monadic testing introduces survey respondents to individual concepts in isolation such that each product or concept is displayed and/or evaluated separately. In some examples, a monadic test can be used to assess how likely someone is to purchase a particular product without the individual's perception of the product being affected by outside influences. While a monadic test is used in product concept testing or packaging research, such testing can also be used in pricing studies, with both qualitative and quantitative studies possible when using a monadic research-based design.

### BRIEF DESCRIPTION OF THE DRAWINGS

FIG. 1 illustrates a block diagram of database engine circuitry, likelihood building engine circuitry, estimation engine circuitry, and post-estimation calculation engine circuitry.

FIG. 2 illustrates a block diagram of the likelihood building engine circuitry of FIG. 1 constructed in accordance with teachings of this disclosure.

FIG. 3 is a flowchart representative of example machine readable instructions that may be executed by example processor circuitry to implement the database engine circuitry, likelihood building engine circuitry, estimation engine circuitry, and/or post-estimation calculation engine circuitry of FIG. 1.

FIG. 4 is a flowchart representative of example machine readable instructions that may be executed by example processor circuitry to identify a combined likelihood using the likelihood building engine circuitry of FIG. 2.

FIG. 5A illustrates a first example distribution of utility value(s) for an average item, including cutoff points, for a five-point scale question set.

FIG. 5B illustrates a second example distribution of utility value(s) for an average item, including cutoff points that are assumed to include error(s) in a five-point scale question set.

FIG. 6A illustrates example results obtained for discrete choice probability and monadic probability associated with purchase intent, where the cutoffs are fixed.

FIG. 6B illustrates example results obtained for discrete choice probability and monadic probability associated with purchase intent, where the cutoffs include noise.

FIG. 7A illustrates example results obtained for discrete choice probability and monadic probability associated with uniqueness, where the cutoffs are fixed.

FIG. 7B illustrates example results obtained for discrete choice probability and monadic probability associated with uniqueness, where the cutoffs include noise.

FIG. 8A illustrates example tabulated results for unadjusted and adjusted likelihood probabilities associated with FIGS. 6A-6B.

FIG. 8B illustrates example tabulated results for unadjusted and adjusted likelihood probabilities associated with FIGS. 7A-7B.

FIG. 9 illustrates an example histogram of a scale factor across three different test studies with six key measures.

FIG. 10A illustrates example tabulated results associated with a snapshot of consumer data obtained in connection with survey testing of respondents.

FIG. 10B illustrates example tabulated results associated with supplementing a monadic testing wave with a discrete choice comparative segment to reduce noise in monadic scores.

FIG. 11A illustrates example results of monadic adjusted shares associated with the tabulated results of FIG. 10A, 10B based on a Gumbel distribution.

FIG. 11B illustrates example results of monadic adjusted shares associated with the tabulated results of FIG. 10A, 10B based on a logistic distribution.

FIG. 12 illustrates an example experimental design for a survey analysis, including snapshots of consumer data that are used to identify output including standard monadic scores and discrete choice adjusted monadic scores.

FIG. 13 illustrates an example experimental design for a survey analysis involving monadic and discrete choice testing, including the testing of different concepts using multiple panels.

FIG. 14 is a block diagram of an example processing platform including processor circuitry structured to execute the example machine readable instructions of FIG. 3, 4 to implement the likelihood building engine circuitry of FIG. 2.

FIG. 15 is a block diagram of an example implementation of the processor circuitry of FIG. 14.

FIG. 16 is a block diagram of another example implementation of the processor circuitry of FIG. 14.

FIG. 17 is a block diagram of an example software distribution platform (e.g., one or more servers) to distribute software (e.g., software corresponding to the example machine readable instructions of FIG. 10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Monadic testing can be used as part of concept testing to assess customer willingness to buy certain product(s) of interest prior to the release of the given product(s). While with monadic testing a respondent is exposed to a single concept and asked a series of questions about the concept, discrete choice (DC) methods focus on presenting the respondent with several alternatives and asked to select from among those presented alternative. The advantage of monadic concepts tests includes their ease of use and convenience, given that monadic testing can be run even when a marketer has a single idea for testing. The context that a respondent relies on when assessing a concept monadically is the respondent's existing background knowledge and experience as a regular shopper and consumer. Given the universality of such a context, scores can be compared from one concept test to another concept test, even if the two tests are not run contemporaneously. By contrast, a DC study is self-contained, given that the context that forms the basis of comparison and resulting assessment is the set of concepts included in the particular study. However, results from one study cannot easily be compared to those from another study, even if these studies are related.

Market research companies thereby can build extensive databases of monadic concept test scores over time. When assessing a new idea, monadic testing can permit market researchers to infer how successful a potential idea may be by comparing a given idea to other ideas in the database. For example, a classification algorithm can be used to compare the scores of a concept being tested to scores of previous concepts tested (e.g., in the same geography and category) along with information about how well such concepts performed in-market when launched. This comparison can be used to predict the likely outcome of a newly launched concept. Other examples of monadic testing results include identifying estimates of volume a manufacturer is likely to sell in the first year post product launch, along with a revenue estimate. In some examples, a set of related concepts can be tested in a wave of monadic tests (e.g., variations and/or embodiments of an idea). However, testing different versions monadically is often unlikely to accurately differentiate between related ideas without resorting to prohibitively large sample sizes, given that the differences between these similar embodiments are often within the confidence interval of the monadic test given a typical sample size (e.g., n=150-200 respondents per concept). For example, given a total of 150 respondents (e.g., n=150), responses to Purchase Intent can be dichotomized into top two selections (e.g., Definitely Would Buy and Probably Would Buy) and bottom three selections (e.g., May or May Not Buy, Probably Would Not Buy, Definitely Would Not Buy). Assuming that 40% of the population at large would answer using the top two selections for one of the embodiments tested in the wave of monadic tests, the confidence interval at the 95% confidence level may be between 32% and 48%. Therefore, meaningful differences between embodiments in the same wave of monadic tests would be statistically indistinguishable. For scores to be usable downstream, the scores need to have the same form (e.g., an average score on a five point scale provided to answer the corresponding survey questions, or a distribution of answers across the five point scale).

Additionally, while testing a set of related concepts in a wave of monadic tests can result in inaccuracies, monadic testing can also suffer from relatively high levels of measurement noise, due to a number of factors (e.g., response scale usage patterns, scale compression, limited number of observations per respondent, etc.). Such measurement noise results in inaccurate scores when using practical panel sizes and poor discrimination when the product developer is trying to decide between different concepts (e.g., when deciding between two or three products or pack redesign(s)).

Discrete choice (DC) methods, however, are superior in terms of panel utilization efficiency and the ability to discriminate between one alternative and a slightly more preferred one. Likewise, DC methods allow for testing of multiple alternatives at once, repeated observations per respondent, and require human respondents to make simple comparisons as opposed to the more demanding task of providing a rating on an absolute internalized scale. However, under certain conditions, DC methods tend to magnify small differences in preference among close product alternatives. As such, this can mislead a product developer into expecting a greater in-market improvement than will ultimately be realized upon launch. Monadic testing, on the other hand, does not magnify small differences in preference among close product alternatives given that monadic testing does not rely on explicit side-by-side comparisons.

Examples disclosed herein address the existing limitations of monadic testing and discrete choice testing by combining these methodologies such that monadic testing can be used to shrink the overstatement of the DC testing, while the DC testing reduces the noise in the scoring and preference ordering of the monadic testing. In the examples disclosed herein, monadic techniques and a discrete choice technique can be used. As previously described, a monadic technique includes presenting to the respondent a concept board that describes the new product concept, and then asking a battery of questions about the concept including purchase interest, novelty, value, and other consumer measures predictive of in-market success. For example, the answers to these questions are typically on a 6-point Likert agreement scale. A respondent may go through more than one monadic technique, each corresponding to a different (e.g., or a different version of a) future product being considered (e.g., an arrangement referred to as a sequential monadic survey). Monadic techniques can be included for the purpose of comparing the scores of the proposed product(s) to existing ones. For example, the proposed product(s) may represent the manufacturer's own product(s), as in the case of a product or package refresh, or proposed product(s) may be competitors' products.

In comparison, the discrete choice technique includes presenting the respondent with one or more choice sets, each including at least two alternatives, representing potential future products and, in some examples, current in-market products. For example, the number of choice sets presented to each respondent can range from 1-16 or more, with 10-12 being typical. The number of alternatives per choice set can range from 2-100 or more, with 3-24 being more typical. The task the respondent is asked to perform is to select the alternative in the given choice set which most closely meets a particular objective. The most common objective is purchase likelihood, where the respondent is asked to select the alternative he or she would be “most likely to purchase”. However, in the methods, systems, articles of manufacture and apparatus disclosed herein, additional choice objectives may be presented to the respondent, corresponding to different questions in the monadic questionnaire. For example, the respondent may be asked to select the alternative that represents the best value, or that is most new and different. Once responses are collected, the data from the two methodologies are combined into an integrated model. In examples disclosed herein, this is accomplished by linking the proportion of respondents giving a concept different ratings in the monadic segment corresponding to that concept's utility as estimated from the DC segment. In examples disclosed herein, an expanded likelihood function is developed, which combines both the likelihood of one product alternative being selected over the others in the DC exercise as well as the likelihood of the product receiving a certain distribution of monadic scores. In the examples disclosed herein, optimal DC utilities and monadic cutoffs are estimated jointly using maximum likelihood estimation, along with a weighting parameter that reflects the relative consistency between the two methodologies. In this process, the monadic scores are modified (e.g., by reducing noise) so they align better with the preference ordering from the DC segment, with the DC utilities also being modified.

Methods, systems, articles of manufacture, and apparatus disclosed herein reduce a signal-to-noise ratio (SNR) of monadic scores by estimating utility value(s) associated with a plurality of products, estimating a discrete choice probability of selection of a given product over existing alternatives based on the utility values, and generating monadic scale question(s) for a given product (e.g., one monadic scale question per product, corresponding to one choice objective). In examples disclosed herein, a monadic probability (e.g., a distribution of monadic scores among five points on a scale) of a given product is calculated for the scale question(s) based on the utility values from the plurality of products. In examples disclosed herein, the signal-to-noise ratio of the monadic probability is reduced by joining the discrete choice probability of selecting a given product with the distribution of monadic scores received by the given product based on a scaling factor indicative of a type of correlation between the discrete choice probability and the monadic probability.

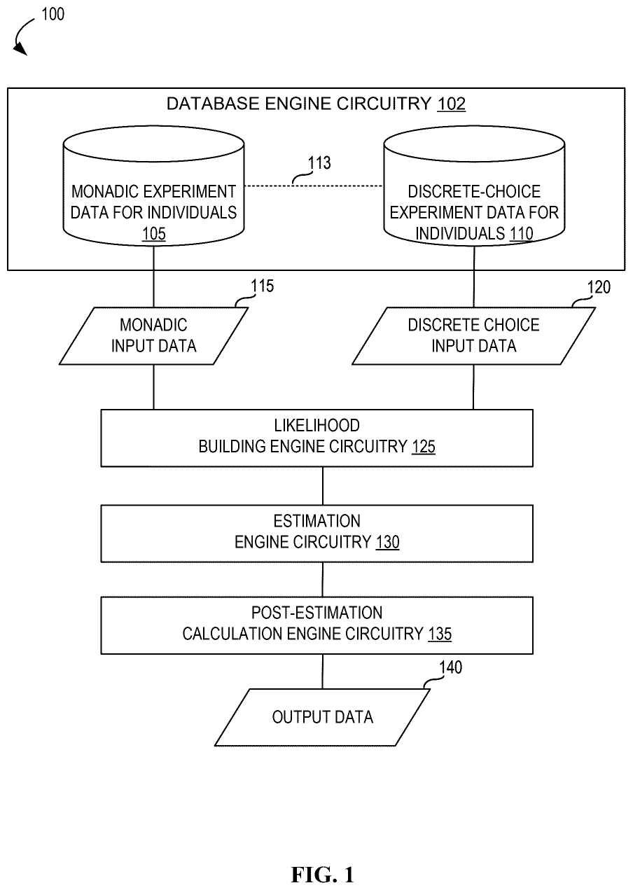

FIG. 1 illustrates a block diagram 100 of database engine circuitry 102, likelihood building engine circuitry 125, estimation engine circuitry 130, and post-estimation calculation engine circuitry 135. In the example of FIG. 1, the database engine circuitry 102 includes monadic experiment data for individuals 105 (e.g., a data storage device) and discrete choice experiment data for individuals 110 (e.g., a data storage device). For example, the monadic experiment data for individuals 105 can include monadic-based experiment data associated with surveys performed using a five-point scale. In some examples, the five-point scale can include response options that identify how likely a respondent is to purchase a given item. In some examples, monadic experiment data for individuals 105 can include data obtained using a concept board that describes the new product concept. A battery of questions about the concept including purchase interest, novelty, value, and/or other consumer measures predictive of in-market success can be stored in the monadic experiment data for individuals 105. Discrete choice experiment data for individuals 110 can include answers derived from discrete choice testing using one or more choice sets, each including a number of alternatives, representing potential future products and, in some examples, current in-market products. In some examples, the number of choice sets presented to each respondent can range from 1-16 or more, with 10-12 being typical, while the number of alternatives per choice set can range from 2-100 or more, with 3-24 being more typical. As such, the information gathered using monadic testing (e.g., using monadic experiment data for individuals 105) and/or discrete-choice testing (e.g., using discrete choice experiment data for individuals 110) can be in the form of example monadic input data 115 and/or discrete choice input data 120. In some examples, the monadic experiment data for individuals 105 and discrete choice experiment data for individuals 110 can be connected (e.g., as shown using example link 113), such that the individuals in the monadic experiment data can also be the same individuals that take a discrete choice survey.

In some examples, the linkage 113 is established based on the selection of an aggregate model, a latent class model, and/or a hierarchical Bayesian model when adjusting the monadic results (e.g., to reduce the signal to noise ratio). For example, the use of an aggregate model does not require that the individuals taking the monadic-based survey are the same individuals that take the discrete choice survey. However, in some examples, the use of a latent class model and/or a hierarchical Bayesian model can require that the linkage 113 exists. In some examples, an aggregate model can be used when the parameters that require estimation (e.g., cutoffs, a scale factor, etc.) are the same across all individuals, such that the aggregate model represents a population of panelists that is homogenous. In some examples, a latent class model can be used when the panelists are classified into groups, such that each group can be considered to be homogenous, thereby allowing a set of parameters to be assigned for each group of individuals. Likewise, a hierarchical Bayesian model can be used to account for heterogeneity in a given population, such that different people are assumed to have different opinions about rated and/or chosen products. As such, the hierarchical Bayesian model can include a set of parameters for each panelist. In the example of FIG. 1, the likelihood building engine circuitry 125 receives the monadic input data 115 and/or the discrete choice input data 120.

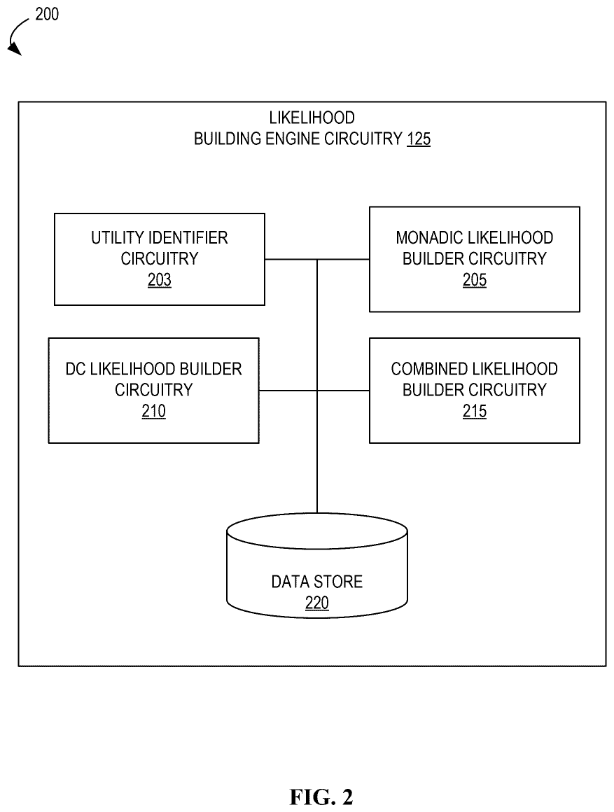

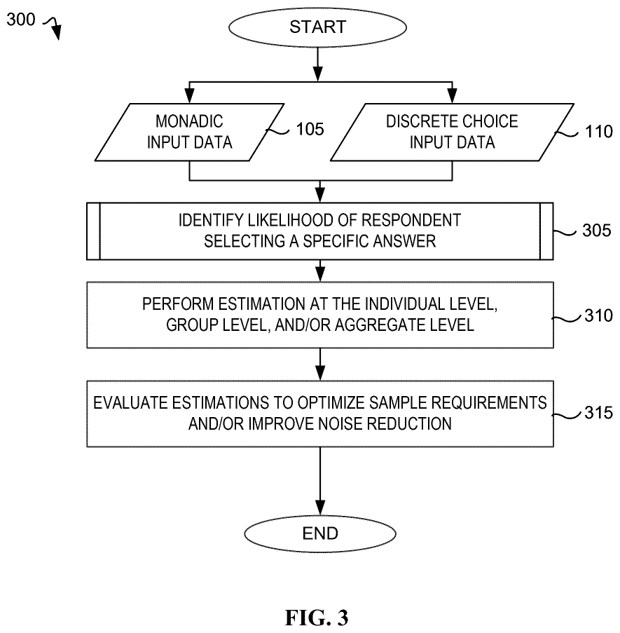

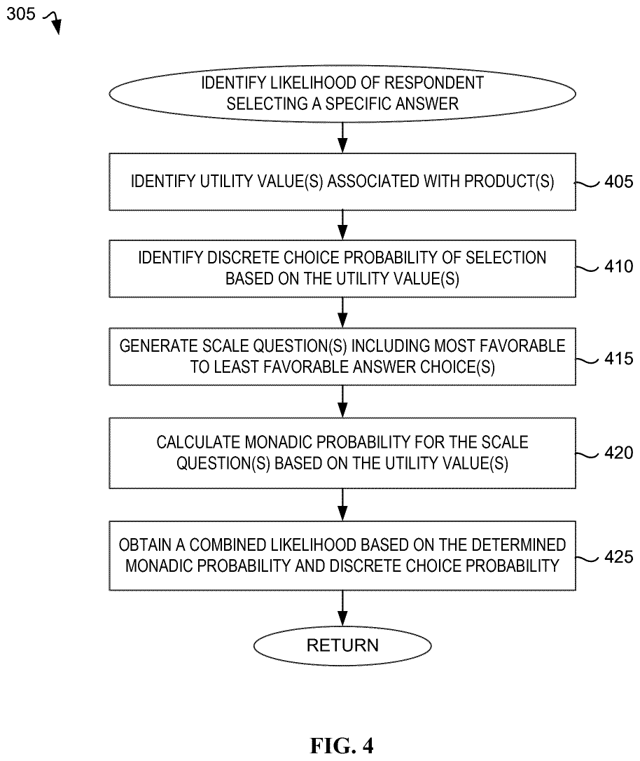

As described in connection with FIG. 2, the example likelihood building engine circuitry 125 identifies a monadic likelihood of a respondent selecting a particular response (e.g., using a monadic likelihood builder circuitry 205) and/or the likelihood building engine circuitry 125 identifies a discrete choice likelihood of a respondent selecting a particular response (e.g., using example discrete choice likelihood builder circuitry 210). Once the monadic and/or DC likelihood is identified, the likelihood building engine circuitry 125 identifies a combined likelihood using the monadic and/or DC likelihoods (e.g., using example combined likelihood builder circuitry 215), as described in connection with FIGS. 3-4. The combined likelihood can be used to reduce the signal-to-noise ratio of the obtained monadic-based testing data. Separately, the example estimation engine circuitry 130 receives the combined likelihood generated using the example likelihood building engine circuitry 125 to perform estimations of likelihoods at an individual level, a group level, and/or an aggregate level, as described in connection with FIG. 3. In some examples, the example post-estimation calculation engine circuitry 135 is used to identify data inconsistencies. In some examples, estimations and/or post-estimations are performed using hierarchical Bayesian models (e.g., at the individual level), latent class models (e.g., at the group level), and/or simple maximum likelihood estimation (e.g., at the aggregate level). Once the analyses are completed using the example likelihood building engine circuitry 125, the example estimation engine circuitry 130, and/or the example post-estimation calculation engine circuitry 135, example final output data 140 is provided to give a user the final likelihood data combined with respondent survey data analysis.

FIG. 2 illustrates a block diagram 200 of the likelihood building engine circuitry 125 of FIG. 1 constructed in accordance with teachings of this disclosure. In the example of FIG. 2, the likelihood building engine circuitry 125 includes a utility identifier circuitry 203, monadic likelihood builder circuitry 205, discrete choice likelihood builder circuitry 210, combined likelihood builder circuitry 215, and/or data storage 220.

The example utility identifier circuitry 203 identifies a utility that can be used for determining the monadic likelihood and/or discrete choice likelihoods. For example, a person depending on a taken action can receive a worth or utility. The utility can be positive or negative and can include a portion that is observable (e.g., estimable) and a portion that is not estimable. For example, during sequential monadic testing, two or more concepts can be evaluated one after another. For example, respondents can be shown one concept at the same time as an alternative concept is shown. Respondents can then be asked the same question(s) about each concept to determine which concept is favorable to the respondent(s). For example, a total of I items (e.g., i=1, . . . , I) can be shown to participants via a sequential monadic. In some examples, after all concepts are shown and respondents are asked about key measure(s) of interest, participants can then be shown choice pages. The selections made by participants using the choice pages form the discrete choice (DC) data. This data, acquired using the example database engine circuitry 102, can be used for further identification of the monadic and/or DC-based likelihoods, as described in more detail below.

In some examples, the utility identifier circuitry 203 identifies a utility based on the concept of utility maximization theory (e.g., individuals seek to receive the highest satisfaction from their economic decisions). For example, a utility can be assigned as follows using Equation 1:

$${U}_{i} = {β}_{i} + {ϵ}_{i} , where i = 1 , … , I \qquad Equation 1$$

As such, Equation 1 represents an aggregate model based on the utility (β) of each item. An individual level model, on the other hand, provides a utility estimate for each item of each individual (e.g., where the utility term is identified as U_{i,j}, where i refers to the item and j refers to the individual). For example, an item can receive a worth or utility (e.g., based on the actions of an entire group of individuals or based on the actions of a particular individual). Such a value can be positive or negative and has an observable (e.g., estimable) portion and a portion which is not observable. In example Equation 1, βᵢ represents the observable component of utility, where ∈ᵢ represents the unobservable an “error” from the true Uᵢ. In the example of Equation 1, the action involves a selection and the person making the selection receives a different utility from selecting different items, where i represents an index of the items (e.g., i=1, . . . , I). In some examples, of the action of the individual is also dependent on the individual (e.g., each individual receives a different utility by taking the same action), then i can include the index of the individual(s) as well. In some examples, indices can include individuals (i), items (j), and/or possible monadic answers (k), as illustrated in more detail below. For example, as previously described, calculations can be based on hierarchical Bayesian models (e.g., at the individual level), latent class models (e.g., at the group level), and/or simple maximum likelihood estimation (e.g., at the aggregate level). Assuming the use of a Bayesian model, the utility can be defined using Uᵢⱼ=Bᵢⱼ+∈ᵢⱼ, where i corresponds to individuals and j corresponds to items. For example, ∈ᵢⱼ can be assumed to be a random variable with a mean of zero and independent from the i and j variables. Likewise, ∈ᵢⱼ can be assumed to be identically distributed according to a probability density function f_{∈}(x) and cumulative distribution function F_{∈}(x) in accordance with example Equation 2:

$$\begin{matrix}{F}_{∈} ( x ) = Prob [ {ϵ}_{ij} \underline{<} x ] \\ = Prob [ ϵ \underline{<} x ] \\ = {\int }_{- ∞}^{x} {f}_{∈} ( x ) dx , {F}_{∈} ( - ∞ ) = 0 , {F}_{∈} ( ∞ ) = 1\end{matrix} \qquad Equation 2$$

Given either F_{∈}(x) or f_{∈}(x), the solution to Equation 2 can be obtained using the example utility identifier circuitry 203. Given the assumption that ∈ᵢⱼ is independent of i and/or j, this variable can be rewritten as ∈, as shown in Equation 2. If an aggregate model is used instead of a Bayesian model, the utility identifier circuitry 203 can convert the cumulative distribution function to an aggregate model-based cumulative distribution function by assigning βᵢⱼ=βⱼ for all individuals. In some examples, the distribution function of the utility can be defined in accordance with example Equation 3:

$$\begin{matrix}{F}_{U} ( u ) = Prob [ {U}_{ij} \underline{<} u ] \\ = Prob [ {β}_{ij} + {ϵ}_{ij} \underline{<} x ] \\ = Prob [ ϵ \underline{<} u - {β}_{ij} ] \\ = {\int }_{- ∞}^{u - {β}_{ij}} {f}_{∈} ( x ) dx\end{matrix} \qquad Equation 3$$

By taking the derivative with respect to u, the utility identifier circuitry 203 can determine that f_{U}(u)=f_{∈}(u−βᵢⱼ). As previously described, Uᵢⱼ may not be fully estimable, while the observable utility (βᵢⱼ) is fully estimable given the distributional assumptions made in connection with Equation 2. Given βᵢⱼ, the probability density of Uᵢⱼ can be illustrated as a standard deviation curve (e.g., where u represents the x-axis and f_{U}(u) represents the y-axis). As such, the higher the density f_{U}(u) around a point u, the higher the chance that the total utility Uᵢⱼ is close to βᵢⱼ. When f_{U}(u) is very small (close to 0), the probability that Uᵢⱼ is in the close neighborhood of u is also small. Once the utility identifier circuitry 203 has determined the utility based on a selected model (e.g., aggregate model, hierarchical Bayesian model, etc.), the monadic likelihood builder circuitry 205 determines the monadic-based measurement.

The example monadic likelihood builder circuitry 205 defines a threshold which quantifies the answer an individual gives to a monadic question associated with item j based on the observable utility (βᵢⱼ) associated with the Bayesian model. For example, for each individual i and a monadic question on a K-point Lickert scale answer, the scalar thresholds can be defined as cᵢₖ, k=1, . . . , K−1, such that −∞<cᵢ₁<cᵢ₂< . . . <c_{iK-1}<∞. Based on an ordinal regression model, the higher the utility of an item for an individual, the more thresholds the item will pass. In some examples, the thresholds cᵢₖ and the observable utility of item j (e.g., βᵢⱼ) can be expressed in a way that the probability of a Lickert answer is mapped to the probability of placement of Uᵢⱼ relative to the thresholds. For example, K=5 indicates that the monadic question has five answers ordered from the most favorable to the least favorable. The example monadic likelihood builder circuitry 205 can define the probability for each such answer as follows:

$$\begin{matrix}P [ Person i favors item j highly ] = {q}_{ij 5} = P [ {c}_{i 4} \leq {U}_{ij} \leq ∞ ] \\ = 1 - P [ {U}_{ij} \leq {c}_{i 4} ] \\ = 1 - {F}_{∈} ( {c}_{i 4} - {β}_{ij} )\end{matrix} \qquad Equation 4$$

$$Equation 5$$

$$\begin{matrix}P [ Person i somewhat favors item j ] = {q}_{ij 4} = P [ {c}_{i 3} \leq {U}_{ij} \leq {c}_{i 4} ] \\ = {F}_{∈} ( {c}_{i 4} - {β}_{ij} ) - {F}_{∈} ( {c}_{i 3} - {β}_{ij} )\end{matrix}$$

$$Equation 6$$

$$\begin{matrix}P [ Person i may or may not favor item j ] = {q}_{ij 3} = P [ {c}_{i 2} \leq {U}_{ij} \leq {c}_{i 3} ] \\ = {F}_{∈} ( {c}_{i 3} - {β}_{ij} ) - {F}_{∈} ( {c}_{i 2} - {β}_{ij} )\end{matrix}$$

$$Equation 7$$

$$\begin{matrix}P [ Person i somewhat does not favors item j ] = {q}_{ij 2} = P [ {c}_{i 1} \leq {U}_{ij} \leq {c}_{i 2} ] \\ = {F}_{∈} ( {c}_{i 2} - {β}_{ij} ) - {F}_{∈} ( {c}_{i 1} - {β}_{ij} )\end{matrix}$$

$$Equation 8$$

$$\begin{matrix}P [ Person i never favors item j ] = {q}_{ij 1} = P [ - ∞ \leq {U}_{ij} \leq {c}_{i 1} ] \\ = {F}_{∈} ( {c}_{i 1} - {β}_{ij} )\end{matrix}$$

If a panelist (e.g., respondent to a survey) selects an option from the five options presented above when the panelist is exposed to item j, the probability of that panelist selecting one of the options can be determined based on the estimates of βᵢⱼ and thresholds cᵢₖ. For example, if the panelist selects the second best answer based on the data available from the database engine circuitry 102 (e.g., monadic experiment data for individuals 105), the monadic likelihood builder circuitry 205 uses Equation 5 as the probability that this event (e.g., the selection of the second best answer) has happened given the estimated parameters and assumptions on the unobserved part of utility ∈.

In some examples, depending on the distributional assumption made for utility ∈, a closed form solution may be achieved. For example, for computational efficiency and/or simplicity of analysis, distributional assumptions can be made that can result in closed form solutions. In some examples, utility ∈ can be assumed to be a Gumbel distribution with a zero mean and a variance of π²/6. In such a case,

$${F}_{∈} ( x ) = {e}^{- {e}^{- x}} .$$

Using the determined equation for F_{∈}(x), Equation 6 can be written as:

$$P [ {c}_{i 2} \leq {U}_{ij} \leq {c}_{i 3} ] = {e}^{- {e}^{- ( {c}_{i 3} - {β}_{ij} )}} - {e}^{- {e}^{- ( {c}_{i 2} - {β}_{ij} )}}$$

In some examples, the monadic likelihood builder circuitry 205 implements a logistic regression model (e.g., logit model), where the logit model is a binomial regression model used to associate a vector of random variables to a binomial random variable. In the case of a logit model, ∈ᵢ (e.g., an error from the truth Uᵢ) follows a standard extreme value (e.g., Gumbel) distribution. For example, the Gumbel distribution (e.g., generalized extreme value distribution type-I) can be used to model the distribution of the maximum (or the minimum) of a number of samples of various distributions. For example, an assumption can be made that a choice page with items [symbol] ⊆{1, . . . , I} is shown to a given participant and the participant has chosen item i ∈ [symbol] . The monadic likelihood builder circuitry 205 expresses the probability of choice (e.g., discrete choice probability, or the probability of choosing item i over the rest of the items) in accordance with Equation 9:

$$\begin{matrix}{p}_{i} = P [ {U}_{i} > {U}_{j} , ∀ j ∈ \{ \backslash i \} ] \\ = P [ {β}_{i} + {ϵ}_{i} > {β}_{j} + {ϵ}_{j} , ∀ j ∈ \{ \backslash i \} ] \\ = P [ {\tilde{e}}_{ij} = {ϵ}_{j} - {ϵ}_{i} < {β}_{i} - {β}_{j} , ∀ j ∈ \{ \backslash i \} ]\end{matrix} \qquad Equation 9$$

In the example of Equation 9, the errors from the truth (∈) are Gumble distributed. For example, ∈, U and β correspond to error(s), truth(s), and observable utilities, respectively, associated with individuals (i) and/or items (j). For example, ∈ᵢ represents an error from the truth Uᵢ and ∈ⱼ represents an error from the truth Uᵢ. Likewise, βᵢ represents the observable utility related to individuals and βⱼ represents the observable utility related to items. In the example of Equation 9, \tilde{e}ᵢⱼ represents a standard logistic distribution with a variance of π²/6, where pᵢ takes the closed form associated with Equation 3:

$${p}_{i} = \frac{{e}^{{β}_{i}}}{{e}^{{β}_{j}}} \qquad Equation 10$$

In the examples described above, the error from the truth (∈) is extreme value distributed. To form an ordered likelihood for the monadic selections presented to a respondent, the same utility model can be used. In some examples, monadic likelihood builder circuitry 205 uses an ordered logit that assumes that ∈ is logistically distributed. In some examples, the monadic likelihood builder circuitry 205 uses a Gumbel distribution and the probability that a given concept i is shown and that a given box k (πᵢₖ) is selected using cutoff points c₁>c₂>c₃>c₄ can be defined based on (1) the probability of the selection “I would definitely buy it” (πᵢ₁) represented using Equation 11, (2) the probability of the selection “I would probably buy it” (πᵢ₂) represented using Equation 12, (3) the probability of the selection “I am somewhat likely to buy it” (πᵢ₃) represented using Equation 13, (4) the probability of the selection “It's unlikely that I would buy it” (πᵢ₄) represented using Equation 14, and (5) the probability of the selection “I would definitely not buy it” (πᵢ₅) represented using Equation 15, as follows:

$${π}_{i 1} = P [ {U}_{i} > {c}_{1} ] = P [ {ϵ}_{i} > {c}_{1} - {β}_{i} ] = 1 - {e}^{- {e}^{{β}_{i} - {c}_{1}}} \qquad Equation 11$$

$${π}_{i 2} = P [ {c}_{2} \leq {U}_{i} \leq {c}_{1} ] = P [ {c}_{2} - {β}_{i} \leq {ϵ}_{i} \leq {c}_{1} - {β}_{i} ] = {e}^{- {e}^{{β}_{i} - {c}_{1}}} - {e}^{- {e}^{{β}_{i} - {c}_{2}}} \qquad Equation 12$$

$${π}_{i 3} = P [ {c}_{3} \leq {U}_{i} \leq {c}_{2} ] = P [ {c}_{3} - {β}_{i} \leq {ϵ}_{i} \leq {c}_{2} - {β}_{i} ] = {e}^{- {e}^{{β}_{i} - {c}_{2}}} - {e}^{- {e}^{{β}_{i} - {c}_{3}}} \qquad Equation 13$$

$${π}_{i 4} = P [ {c}_{4} \leq {U}_{i} \leq {c}_{3} ] = P [ {c}_{4} - {β}_{i} \leq {ϵ}_{i} \leq {c}_{3} - {β}_{i} ] = {e}^{- {e}^{{β}_{i} - {c}_{3}}} - {e}^{- {e}^{{β}_{i} - {c}_{4}}} \qquad Equation 14$$

$${π}_{i 5} = P [ {U}_{i} \leq {c}_{4} ] = P [ {ϵ}_{i} \leq {c}_{4} - {β}_{i} ] = {e}^{- {e}^{{β}_{i} - {c}_{4}}} \qquad Equation 15$$

As such, the monadic likelihood builder circuitry 205 identifies the monadic probabilities associated with Equations 11-15.

The example DC likelihood builder circuitry 210 identifies the likelihood associated with discrete choice-based testing. For example, in discrete choice experiments, individuals are asked the same questions that were asked monadically, but the questions are asked in a choice-based setting. For example, instead of asking “How likely are you to buy this item on your next shopping trip?” (e.g., monadic), the survey question can ask “Among the items shown below, which one are you most likely to buy?” (e.g., discrete choice). Therefore, in a similar manner to the monadic likelihood estimation determined using the monadic likelihood builder circuitry 205, the DC likelihood builder circuitry 210 determines the discrete choice likelihood in-line with the utility maximization theory. For example, the probability that individual i chooses item j over other items in a discrete choice task t can be expressed as Pᵢⱼₜ=P[Uᵢⱼ>Uᵢₗ, ∀l ≠j, l∈Sₜ], where Sₜ⊂{1, . . . , J} is the set of items shown to an individual as part of a discrete choice task t. If j is not in the set Sₜ, then Pᵢⱼₜ=0. Based on the calculations performed using the monadic likelihood builder circuitry 205, the DC likelihood builder circuitry 210 can determine the discrete choice probability based on Equation 16:

$$\begin{matrix}{P}_{ijt} = P [ {β}_{i j} + {ϵ}_{i j} > {β}_{i l} + {ϵ}_{il} , ∀ l \neq j , l ∈ {S}_{t} ] \\ = P [ {ϵ}_{il} - {ϵ}_{i j} < {β}_{i j} - {β}_{il} , ∀ l \neq j , l ∈ {S}_{t} ]\end{matrix} \qquad Equation 16$$

In some examples, the DC likelihood builder circuitry 210 calculates the multi-dimensional integral of Equation 16 using numerical Monte-Carlo simulations. However, in some examples, the final solutions that are obtained can be in closed form. For example, assuming that

$${F}_{∈} ( x ) = {e}^{- {e}^{- x}} ,$$

such that the unobservable portion of the utility is Gumbel distributed, the discrete choice likelihood builder circuitry 210 can identify that σᵢⱼₗ=∈ᵢₗ−∈ᵢⱼ is distributed according to logistic distribution for all individuals i and/or items j. Based on such an identification, a standard logit formula commonly used in pure discrete choice models can be applied in accordance with Equation 17:

$${P}_{ijt} = \frac{{e}^{{β}_{ij}}}{{\sum }_{l ϵ {S}_{t}} {e}^{{β}_{i l}}} \qquad Equation 17$$

As such, the discrete choice likelihood builder circuitry 210 can apply Pᵢⱼₜ as the probability that a particular event will occur (e.g., a respondent and/or panelist will choose item j over the rest of the items presented) based on the estimates for the observable utility for an item βᵢⱼ, where j=1, . . . , J.

The discrete choice likelihood builder circuitry 210 also accounts for differences in participant experiences using discrete choice segments. For example, a scale factor K can be defined in the range of [0,1] to reflect higher noise in monadic testing:

$${p}_{i} = \frac{{e}^{{β}_{i} / K}}{{\sum }_{j ϵ 𝒥} {e}^{{β}_{j} / K}} \qquad Equation 18$$

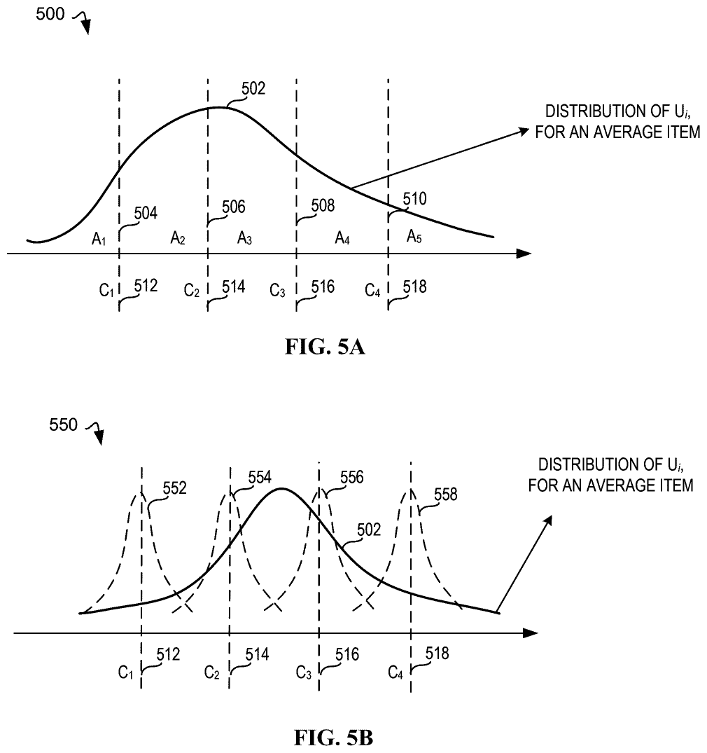

In some examples, the determined probabilities can be further modified by accounting for potential errors associated with cutoff values, as described in connection with FIGS. 5A-5B. For example, the probability of the selection “I would probably buy it” (πᵢ₂) represented using Equation 12 above could be rewritten in accordance with Equation 19 below:

$$\begin{matrix}{π}_{i 2} = P [ {c}_{2} + {δ}_{2} \leq {U}_{i} \leq {c}_{1} + {δ}_{1} ] \\ = P [ {c}_{2} - {β}_{i} \leq {ϵ}_{i} - {δ}_{2} ∧ {ϵ}_{i} - {δ}_{1} \leq {c}_{1} - {β}_{i} ] \\ = \frac{{e}^{{c}_{1}}}{{e}^{{β}_{i}} + {e}^{{c}_{1}}} \times \frac{{e}^{{β}_{i}}}{{e}^{{β}_{i}} + {e}^{{c}_{2}}}\end{matrix} \qquad Equation 19$$

In the example of Equation 19, the last expression can be obtained assuming δⱼ, where j=1, . . . , 4, is also based on the Gumbel distribution and independent of ∈ᵢ's. As such, all logit expressions are obtained for the probabilities πᵢ₁, πᵢ₂, πᵢ₃, πᵢ₄, πᵢ₅. As such, given the example of Equation 19, the probabilities of πᵢ₁, πᵢ₃, πᵢ₄, and/or πᵢ₅ can be similarly computed and combined with DC probabilities to identify the likelihood for monadic selections.

In some examples, the discrete choice likelihood builder circuitry 210 uses a scale factor to capture the relative difference of error magnitudes. For example, a factor that symbolizes the relative difference between the magnitude or unobservable utilities in the monadic and DC processes can be used given that it is natural to think of monadic and discrete choice experiments as very different processes with different unobservable utility or error term(s). In some examples, the discrete choice likelihood builder circuitry 210 modifies Equation 16 by adding a scale factor α>0, thereby resulting in Equation 20:

$$\begin{matrix}{P}_{ijt} = P [ {αβ}_{i j} + {ϵ}_{i j} > α {β}_{il} + {ϵ}_{il} , ∀ l \neq j , l ∈ {S}_{t} ] \\ = P [ {ϵ}_{il} - {ϵ}_{i j} < α ( {β}_{i j} - {β}_{il} ) , ∀ l \neq j , l ∈ {S}_{t} ]\end{matrix} \qquad Equation 20$$

Applying the simplifying assumption that

$${F}_{∈} ( x ) = {e}^{- {e}^{- x}} ,$$

Equation 20 can be modified to obtain Equation 21:

$${P}_{ijt} = \frac{{e}^{α {β}_{i j}}}{{\sum }_{l = 1}^{J} {e}^{α {β}_{i l}}} \qquad Equation 21$$

Therefore, the discrete choice likelihood builder circuitry 210 allows for an identification of the discrete choice likelihood probabilities associated with a respondent selecting a particular response during discrete choice testing.

The combined likelihood builder circuitry 215 identifies a combined likelihood based on the monadic and discrete choices made by survey respondents. For example, a dataset obtained from panelists includes the actions each individual has logged while completing the survey(s). These datasets include monadic input data 105 and discrete choice input data 110. Assuming independence between individual's actions, a combined likelihood can be obtained for each individual i by multiplying the action probabilities obtained using the monadic likelihood builder circuitry 205 and the DC likelihood builder circuitry 210. For example, for monadic-based probabilities, the combined likelihood builder circuitry 215 can use Equation 3 (e.g., distribution function of the utility) and for discrete choice probabilities, the combined likelihood builder circuitry 215 can use Equation 20 (e.g., a modification of Equation 16). In general, individuals can be exposed to many items monadically and can go through multiple discrete choice tasks, such as when the number of items to be examined is large. In some examples, the combined likelihood can be obtained using Equation 22, where Nᵢ and Tᵢ represent the number of monadic tasks per individual i, and kₙ represents the answer an individual i logs at his or her nth monadic task:

$${L}_{i} ( {β}_{i 1} , … , {β}_{ij} , {c}_{i 1} , … , {c}_{iK - 1} , α ) = {\prod }_{n = 1}^{{N}_{i}} {q}_{{ijk}_{n}} ( {β}_{i 1} , … , {β}_{ij} , {c}_{i 1} , … , {c}_{iK - 1} ) \times {\prod }_{t = 1}^{{T}_{i}} {p}_{ijt} ( {β}_{i 1} , … , {β}_{ij} , α ) \qquad Equation 22$$

Once the combined likelihood builder circuitry 215 identifies a combined likelihood based on the monadic and discrete choices, the estimation engine circuitry 130 estimates values associated with the likelihood functions (e.g., β₁, . . . , βₗ), c₁, . . . , c₄, K) to obtain the adjusted monadic probabilities (e.g., πᵢⱼ). For example, the adjusted monadic score can include the adjusted monadic probabilities in a simplified weighted sum, as shown in connection with Equation 23:

$${s}_{i} = 5 \times {π}_{i 5} + 4 \times {π}_{i 4} + … + 1 \times {π}_{i 1} , for i = 1 , … , I \qquad Equation 23$$

In the example of Equation 23, the coefficients represent weights for each answer selected (e.g., for a total of five different answer choices), such that if all individuals select the fifth choice (e.g., associated with the probability πᵢ₅), all other scores will be equated to zero, and the final score will be 5 (e.g., corresponding to the respondents' selections of only the fifth answer choice), as shown in connection with Equation 15.

The data storage 220 can be used to store any information associated with the monadic likelihood builder circuitry 205, discrete choice likelihood builder circuitry 210, and/or combined likelihood builder circuitry 215. The example data storage 220 of the illustrated example of FIG. 2 can be implemented by any memory, storage device and/or storage disc for storing data such as flash memory, magnetic media, optical media, etc. Furthermore, the data stored in the example data storage 220 can be in any data format such as binary data, comma delimited data, tab delimited data, structured query language (SQL) structures, image data, etc.

While an example manner of implementing the likelihood building engine circuitry 125 of FIG. 1 is illustrated in FIG. 2, one or more of the elements, processes, and/or devices illustrated in FIG. 2 may be combined, divided, re-arranged, omitted, eliminated, and/or implemented in any other way. Further, the example utility identifier circuitry 203, the example monadic likelihood builder circuitry 205, the example DC likelihood builder circuitry 210, the example combined likelihood builder circuitry 215, and/or, more generally, the example likelihood building engine circuitry 125 of FIG. 2, may be implemented by hardware, software, firmware, and/or any combination of hardware, software, and/or firmware. Thus, for example, any of the example utility identifier circuitry 203, the example monadic likelihood builder circuitry 205, the example DC likelihood builder circuitry 210, the example combined likelihood builder circuitry 215, and/or, more generally, the example likelihood building engine circuitry 125 of FIG. 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example utility identifier circuitry 203, the example monadic likelihood builder circuitry 205, the example DC likelihood builder circuitry 210, the example combined likelihood builder circuitry 215, and/or, more generally, the example likelihood building engine circuitry 125 of FIG. 2, is/are hereby expressly defined to include a non-transitory computer readable storage device or storage disk such as a memory, a digital versatile disk (DVD), a compact disk (CD), a Blu-ray disk, etc., including the software and/or firmware. Further still, the example likelihood building engine circuitry 125 of FIG. 2 may include one or more elements, processes, and/or devices in addition to, or instead of, those illustrated in FIG. 2, and/or may include more than one of any or all of the illustrated elements, processes and devices.

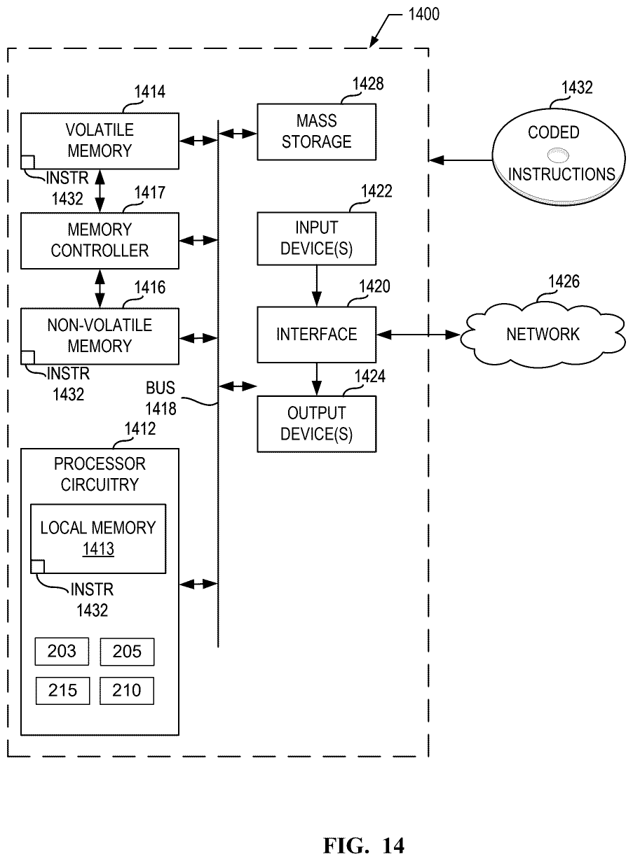

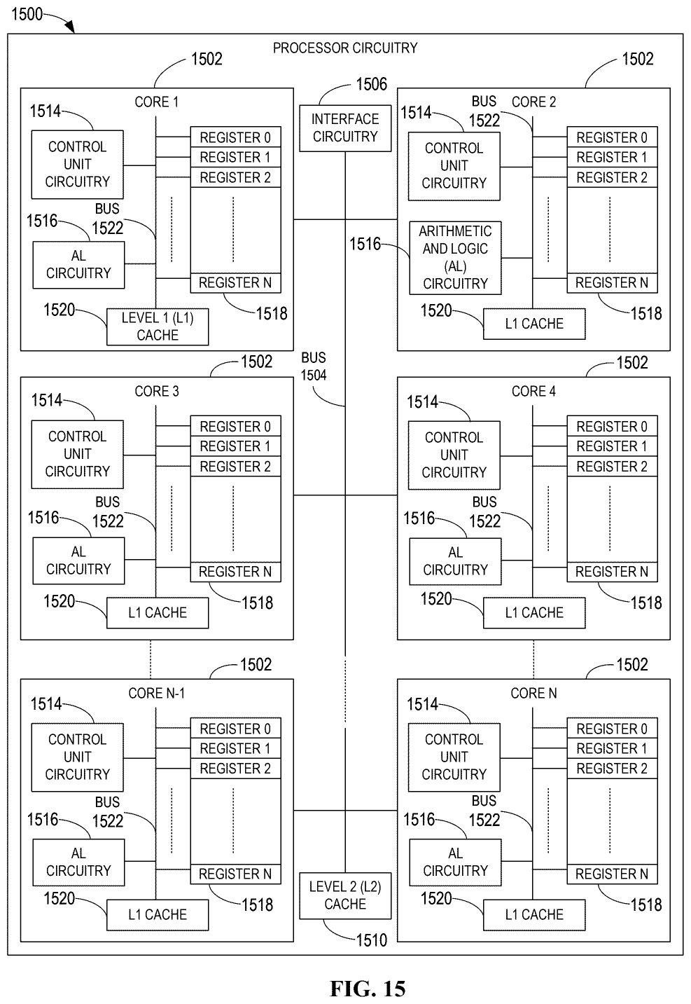

Flowcharts representative of example hardware logic circuitry, machine readable instructions, hardware implemented state machines, and/or any combination thereof for implementing the likelihood building engine circuitry 125 of FIG. 2 are shown in FIGS. 3-4. The machine readable instructions may be one or more executable programs or portion(s) of an executable program for execution by processor circuitry, such as the processor circuitry 1412 shown in the example processor platform 1400 discussed below in connection with FIG. 14 and/or the example processor circuitry discussed below in connection with FIGS. 15 and/or 16. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3-4, many other methods of implementing the example likelihood building engine circuitry 125 of FIG. 2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions 300 that may be executed by example processor circuitry 1412 to implement the database engine circuitry 102, likelihood building engine circuitry 125, estimation engine circuitry 130, and/or post-estimation calculation engine circuitry 135 of FIG. 1. In the example of FIG. 3, the database engine circuitry 102 provides the monadic input data 105 (e.g., generated based on respondent answers to a monadic-based survey) and/or discrete choice input data 110 (e.g., generated based on respondent answers to a discrete choice-based survey) to the likelihood building engine circuitry 125. In some examples, the individuals (e.g., respondents) associated with the monadic input data 105 are the same individuals associated with the discrete choice input data 110. In some examples, the respondents across the two survey categories are not the same, which can determine the type of modeling performed as part of the likelihood building engine circuitry 125, estimation engine circuitry 130, and/or post-estimation calculation engine circuitry 135 (e.g., aggregate-based modelling, latent class-based modelling, hierarchical Bayesian-based modeling). Once the survey-based responses are available, the likelihood building engine circuitry 125 identifies the likelihood of a respondent selecting a specific answer (block 305), as described in more detail in connection with FIG. 4. For example, the likelihood building engine circuitry 125 identifies discrete choice probabilities and/or monadic probabilities associated with the monadic input data 105 and the discrete choice input data 110. Furthermore, the likelihood building engine circuitry 125 identifies a combined likelihood based on the determined discrete choice probabilities and/or monadic probabilities, which can assist in the identification of adjusted monadic scores to reduce the signal-to-noise ratio resulting from using monadic testing.

For example, monadic tests may not reflect realistic decision-making situations in which a consumer is comparing different product offerings at the point of purchase. As previously described, using multiple monadic tests to compare concepts during the product development process can be ineffective. By using discrete choice observations to supplement the monadic scores, methods and apparatus disclosed herein permit for a more accurate assessment of customer-based decision making. Therefore, methods, systems, articles of manufacture, and apparatus disclosed herein permit the improvement of the signal-to-noise ratio of monadic testing which includes the testing of more than one concept (e.g., a panel is divided between different concepts).

Adjusting the signal-to-noise ratio of monadic scores can be done by identifying whether the monadic scores are inconsistent with the less noise-prone DC results. Once the combined likelihood is determined using the likelihood building engine circuitry 125, the estimation engine circuitry 130 performs estimates of likelihoods and/or probabilities at an individual level, a group level, and/or an aggregate level (block 310). As previously described, the different levels of estimation correspond to evaluating responses to surveys at different stages (e.g., aggregate versus individual, etc.) using adjusted monadic scores. In some examples, the estimation engine circuitry 130 estimates values associated with the likelihood functions to obtain the adjusted monadic probabilities. Separately, the post-estimation calculation engine circuitry 135 performs post estimations to identify changes to the likelihood estimation process to improve the monadic signal-to-noise ratio (block 315). In some examples, the post-estimation calculation engine circuitry 135 optimizes sample requirements to determine monadic scores at a higher level of accuracy.

FIG. 4 is a flowchart representative of example machine readable instructions 305 that may be executed by example processor circuitry 1412 to identify a combined likelihood using the likelihood building engine circuitry 125 of FIG. 2. In the example of FIG. 4, the utility identifier circuitry 203 identifies utility value(s) associated with product(s) (block 405). For example, as described in connection with FIG. 2, the utility identifier circuitry 203 identifies a utility that can be used for determining the monadic likelihood and/or discrete choice likelihoods. The utility can be positive or negative and can include a portion that is observable (e.g., estimable) and a portion that is not estimable. In some examples, the utility identifier circuitry 203 identifies a utility based on the concept of utility maximization theory for an aggregate model (e.g., Uᵢ=βᵢ+∈ᵢ), where the parameters are the same across all individuals (e.g., homogenous population of panelists). In some examples, the utility identifier circuitry 203 identifies a utility based on an individual-level hierarchical Bayesian model (e.g., Uᵢⱼ=βᵢⱼ+∈ᵢⱼ), where i corresponds to individuals and j corresponds to items (e.g., heterogeneous population of panelists). In some examples, based on the identified utility values, the DC likelihood builder circuitry 210 identifies a discrete choice probability of selection (block 410). For example, the DC likelihood builder circuitry 210 determines the discrete choice likelihood in-line with the utility maximization theory. For example, the probability that individual i chooses item j over other items in a discrete choice task t can be expressed as Pᵢⱼₜ=P[Uᵢⱼ>Uᵢₗ, ∀l≠j, l∈Sₜ], where Sₜ⊂{1, . . . , J} is the set of items shown to an individual as part of a discrete choice task t, as described in connection with FIG. 2. In some examples, the DC likelihood builder circuitry 210 determines the discrete choice probability based on Equation 16.

Once the discrete choice probability is identified, the monadic likelihood builder circuitry 205 determines the monadic likelihood based on a generated scale of questions including most favorable to least favorable answer choice(s) (block 415). However, the order of the likelihood estimation can be in any other sequence, and is not limited to the sequence presented in connection with FIG. 4. For example, the monadic likelihood builder circuitry 205 can perform monadic likelihood estimation prior to the discrete choice likelihood estimation, depending on the availability of results and/or the experimental set-up. In the example of FIG. 4, the monadic likelihood builder circuitry 205 calculates the monadic probability for the scale question(s) based on the utility value(s) identified using the utility identifier circuitry 203 (block 420). As described in connection with FIG. 2, the monadic likelihood builder circuitry 205 defines the monadic probability for each answer in the generated scale question(s) in accordance with Equations 4-8 and/or Equations 11-15. Once the monadic probability and the discrete choice probability is determined, the combined likelihood builder circuitry 215 obtains a combined likelihood based on the determined monadic probability and discrete choice probability (block 425). For example, the combined likelihood builder circuitry 215 identifies the combined likelihood using Equation 22 based on the number of monadic tasks per individual and the answer an individual logs during the monadic task.

FIG. 5A illustrates a first example distribution 500 of utility value(s) for an average item 502, including cutoff points, for a five-point scale question set. FIG. 5B illustrates a second example distribution 550 of utility value(s) for an average item, including cutoff points that are assumed to include error(s) in a five-point scale question set. As described above, monadic scores can be adjusted using discrete choice (DC) data. For example, monadic questions can require answers on a five-point scale for a given concept, while DC-based experiments employ relative comparisons between concepts. DC data can be used to adjust the monadic scores since the results for the monadic and DC-based analysis are expected to be at least directionally the same (e.g., same order of concepts and/or same relative differences). In examples disclosed herein, average monadic scores are minimally affected across concepts so that recalibration is not needed downstream. In examples disclosed herein, the monadic scores are corrected when the monadic scores are noisy and are not in line with the relatively less noise-producing DC experiment results. For example, a signal-to-noise ratio (SNR) of the monadic probability can be reduced by joining the DC probability of selection of a given product with the monadic probability of selecting the given product based on a scaling factor indicative of a type of correlation between the DC probability and the monadic probability.

As previously described in connection with FIG. 2, discrete choice (DC) probabilities can be identified by assuming a total of I items, where Γ={1, . . . , I}. An aggregate model can be identified using Uᵢ=βᵢ+∈ᵢ (Equation 1) to define the utility of each item (Uᵢ). Using such terms, the probability of choosing item i over the rest of the given items can be defined such that pᵢ=P[Uᵢ≥Uⱼ, ∀j∈Γ\i]=P[\tilde{e}ᵢⱼ=∈ⱼ−∈ᵢ≤βᵢ−βⱼ, ∈Γ\i]. Separately, monadic probabilities can also be based on the utility of each item (Uᵢi). For a five-point scale question, a total of four cut-off points can be defined, as shown in connection with FIG. 5A (e.g., cut-off points c₁, c₂, c₃, c₄ as defined using example cutoffs 512, 514, 516, 518), where Uᵢ is shown as a distribution for average item(s) 504, 506, 508, 510 (e.g., A₁, A₂, A₃, A₄, A₅). As such, the probability of selecting box j for an item i can be defined as πᵢⱼ=Aⱼ. For example, πᵢ₂=A₂=P[Uᵢ∈[c₁, c₂)] and πᵢ₅=A₅=P[Uᵢ∈[c₄, ∞)]. Using a Gumbel distribution for ∈ᵢ (e.g., error from the truth Uᵢ) and assuming that

$$P [ {U}_{i} \leq {c}_{j} ] = P [ {ϵ}_{i} \leq {c}_{j} - {β}_{i} ] = {e}^{- {e}^{{β}_{i} - {c}_{j}}} ,$$

the monadic probabilities for a five-point scale question can be defined as follows:

$$\begin{matrix}Would definitely buy I & {π}_{i 5} = 1 - {e}^{- {e}^{{β}_{i} - {c}_{4}}} \\ Would probably buy I & {π}_{i 4} = {e}^{- {e}^{{β}_{i} - {c}_{4}}} - {e}^{- {e}^{{β}_{i} - {c}_{3}}} \\ Somewhat likely to buy I & {π}_{i 3} = {e}^{- {e}^{{β}_{i} - {c}_{3}}} - {e}^{- {e}^{{β}_{i} - {c}_{2}}} \\ Unlikely to buy I & {π}_{i 2} = {e}^{- {e}^{{β}_{i} - {c}_{2}}} - {e}^{- {e}^{{β}_{i} - {c}_{1}}} \\ Definitely would not buy I & {π}_{i 1} = {e}^{- {e}^{{β}_{i} - {c}_{1}}}\end{matrix}$$

In some examples, to perform a more thorough analysis, cutoffs (e.g., cut-off points c₁, c₂, c₃, c₄) can also be assumed to have an error (67 ⱼ), such that Cⱼ=cⱼ+δⱼ and both δⱼ and ∈ᵢ are assigned a Gumbel distribution, as shown in connection with FIG. 5B, showing example cutoff errors 552, 554, 556, 558. For example,

$${π}_{i 3} = P [ {U}_{i} ∈ [ {C}_{2} , {C}_{3} ] = P [ {c}_{2} + {δ}_{2} \leq {β}_{i} + {ϵ}_{2} < {c}_{3} + {δ}_{3} ] = P [ {c}_{2} - {β}_{i} \leq {ϵ}_{2} - {δ}_{2} ∧ {ϵ}_{2} - {δ}_{3} < {c}_{3} - {β}_{i} ] = \frac{{e}^{{β}_{i}}}{{e}^{{β}_{i}} + {e}^{{c}_{2}}} \times \frac{{e}^{{c}_{3}}}{{e}^{{β}_{i}} + {e}^{{c}_{3}}} .$$

Overall, the two described methods of determining monadic probabilities are essentially the same, with the key difference between the methodologies being the use of cutoff value(s) and/or scale factor(s).

An overall likelihood can be determined based on the DC likelihood and monadic likelihood combination, which can be achieved by multiplying the DC and monadic probabilities. For example, to account for the fact that DC experiments are less noisy, a scale factor can be introduced into the DC probabilities, such that

$${p}_{i} = \frac{{e}^{{β}_{i} / K}}{{\sum }_{j ϵ Γ} {e}^{{β}_{j} / K}} ,$$

where K is generally in the range of (0,1), providing that DC experiments are more reliable. In some examples, K can become slightly negative if monadic and DC probabilities are negatively correlated. In the examples disclosed herein, the combined monadic/DC likelihood can be a function of β₁, . . . , β_{I} (e.g., observable utility related to items), c₁, . . . , c₄ (e.g., cutoff points), and K (e.g., scale factor), where cₗ can be set as the default. The adjusted monadic probabilities (πᵢⱼ) can therefore be calculated after the β₁, . . . , β_{I}, c₁, . . . , c₄, and K values are obtained. The final monadic score can be determined based on a simple weighted sum (sᵢ), which can be defined as sᵢ=5×πᵢ₅+4×πᵢ₄+ . . . +1×πᵢₗ, for i=1, . . . , I, as described in connection with FIG. 2.

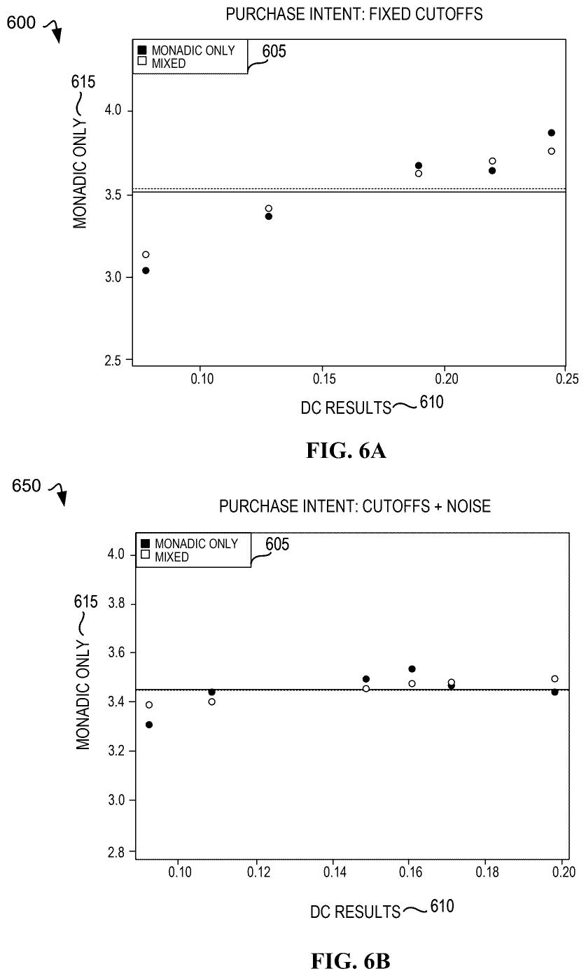

FIG. 6A illustrates example results 600 obtained for discrete choice probability and monadic probability associated with purchase intent, where the cutoffs are fixed. FIG. 6B illustrates example results 650 obtained for discrete choice probability and monadic probability associated with purchase intent, where the cutoffs include noise. In the example of FIGS. 6A and 6B, projections are shown based on key metrics for each of which a monadic test was run per concept and per participant in the associated concept base size. Additionally, DC-based experiments can be run for the key metrics. In the examples disclosed herein, the analysis was applied using cutoffs only and cutoffs with noise, with the adjusted scores for the two cases shown to be very close to each other. In some examples, due to the shape of the error distributions, using the first method of identifying monadic-based probabilities results in the cutoffs (e.g., c₁, . . . , c₄) being closer together and the scale factor (K) being smaller. In the example of FIG. 6A, the x-axis represents discrete choice results 610 while the y-axis represents monadic only results 615 using fixed cutoffs. The graph illustrates results 605 obtained for monadic only and mixed data (e.g., including both monadic and discrete choice data). Overall, the monadic only results 615 show relatively good alignment with the DC results 610.

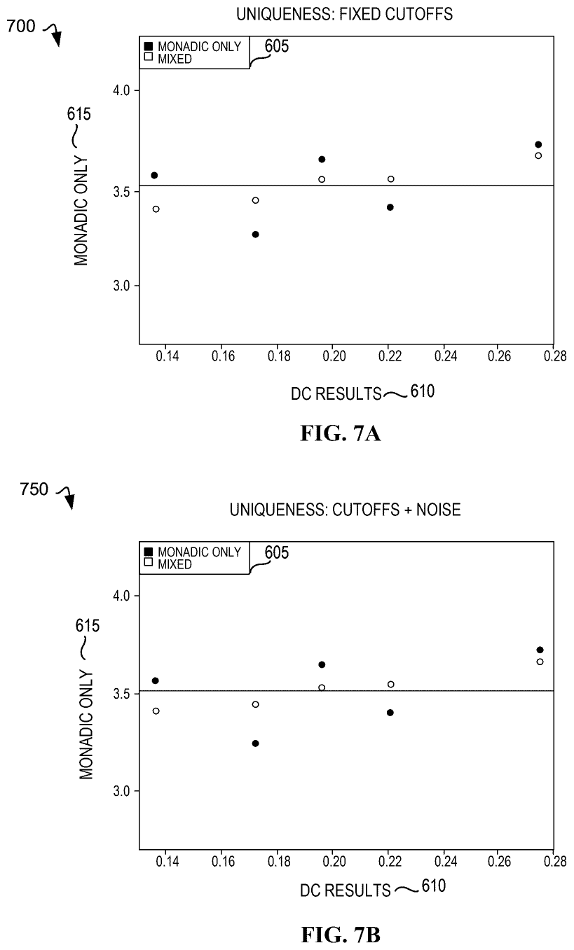

FIG. 7A illustrates example results 700 obtained for discrete choice probability and monadic probability associated with uniqueness, where the cutoffs are fixed. FIG. 7B illustrates example results 750 obtained for discrete choice probability and monadic probability associated with uniqueness, where the cutoffs include noise. Unlike in the example of FIGS. 6A, 6B, the monadic only results 615 do not have relatively good alignment with the DC results 610. However, the use of a mixed monadic improves the alignment for both results 700 (without the use of cutoff noise) and results 750 (with the use of cutoff noise), determined as described in connection with FIGS. 5A, 5B.

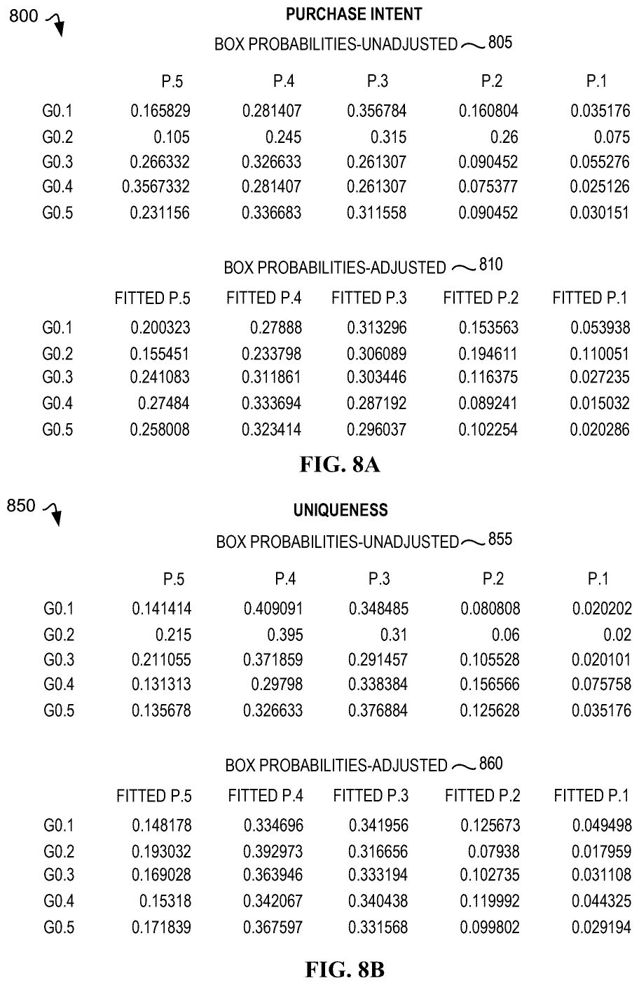

FIG. 8A illustrates example tabulated results 800 for unadjusted and adjusted likelihood probabilities associated with FIGS. 6A-6B. FIG. 8B illustrates example tabulated results 850 for unadjusted and adjusted likelihood probabilities associated with FIGS. 6A-6B. In the example of FIGS. 8A, 8B, the box probabilities (e.g., corresponding to answer choice selection probabilities) include unadjusted probabilities 805, 855 and adjusted probabilities 810, 860. For example, in FIG. 8A, the value of the scale factor (K) is 0.56, showing that the monadic data is about two times noisier than the discrete choice data. For example, in FIG. 8B, the value of the scale factor (K) is 0.44, showing that the monadic data is much noisier than in the data presented in connection with FIG. 8A.

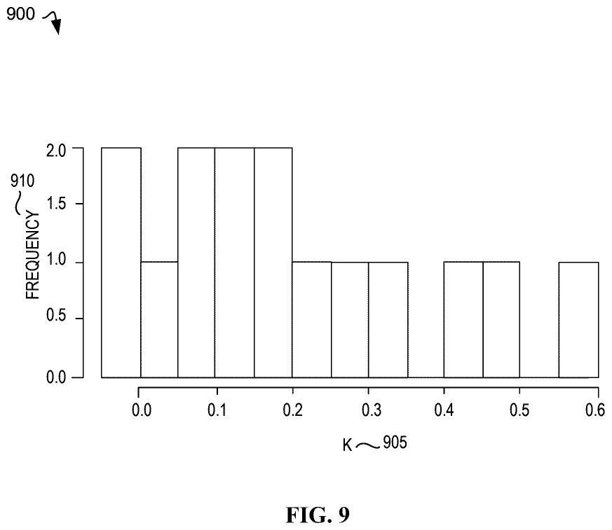

FIG. 9 illustrates an example histogram 900 of a scale factor (K) 905 across three different test studies with six key measures, with example frequency 910 of the scale factor 905 shown on the y-axis. For example, K can become slightly negative if monadic and discrete choice probabilities show high levels of negative correlation. As previously described in connection with Equation 18, the scale factor K can be defined in the range of [0,1] to reflect higher noise in monadic testing. In some examples, the discrete choice likelihood builder circuitry 210 uses the scale factor to identify the relative difference of error magnitudes, as described in connection with FIG. 2.

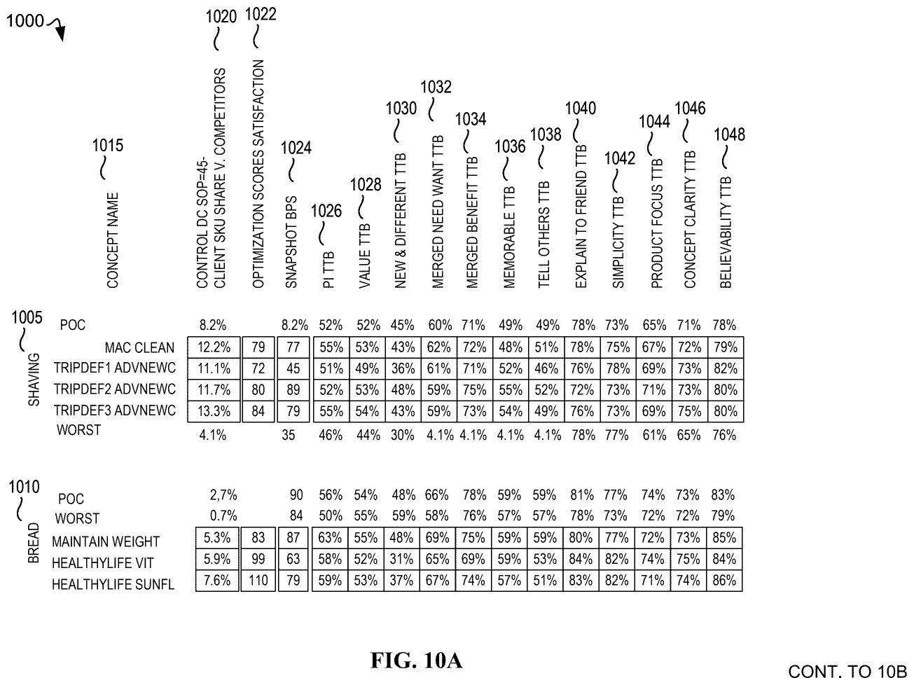

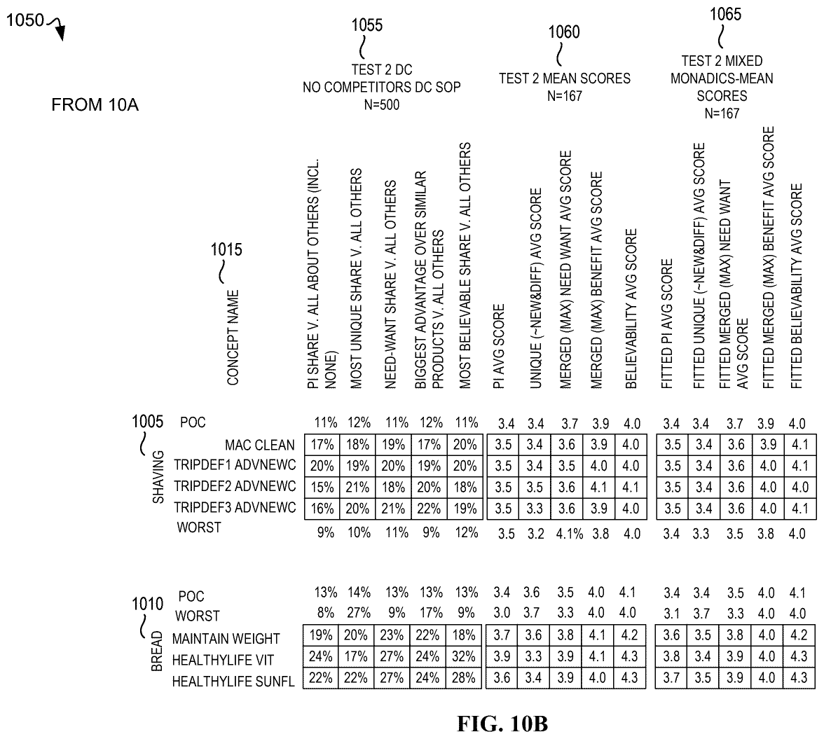

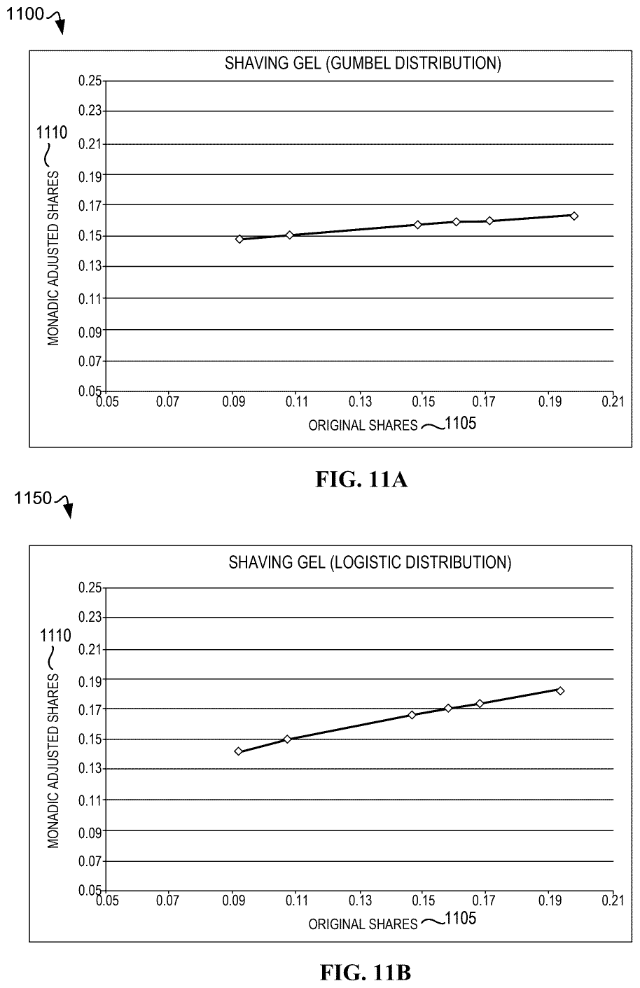

FIG. 10A illustrates example tabulated results 1000 associated with a snapshot of consumer data obtained in connection with survey testing of respondents. FIG. 10B illustrates example tabulated results 1050 associated with supplementing a monadic testing wave with a discrete choice comparative segment to reduce noise in monadic scores. In the example of FIG. 10A, 10B, results 1000, 1050 include data associated with testing using a particular concept (e.g., concept testing associated with a shaving product 1005 and concept testing associated with a bread product 1010, as identified using example concept name(s) 1015). Graphical results associated with the shaving product 1005 are shown in connection with FIGS. 11A, 11B, while graphical results associated with the bread product 1010 are shown in connection with FIGS. 6A, 6B, 7A, 7B. In the example of FIG. 10A, 10B, monadic interviews are supplemented with a discrete choice comparative segment whenever two or more concepts are tested in a monadic testing wave. For example, DC data is incorporated into the testing to reduce noise in monadic scores using the methods and apparatus disclosed in connection with FIGS. 1, 2, 3, 4. In the example of FIG. 10A, different concept assessments 1020, 1022, 1024, 1025, 1028, 1030, 1032, 1034, 1036, 1038, 1040, 1042, 1044, 1046, 1048 are performed to capture snapshots of consumer data. In the example of FIG. 10B, results for the concept testing associated with a shaving product 1005 and concept testing associated with a bread product 1010 are shown, including discrete choice-based results 1055, mean scores 1060, and mixed monadic mean scores 1065.

FIG. 11A illustrates example results of monadic adjusted shares 1100 associated with the tabulated results of FIG. 10A, 10B based on a Gumbel distribution. FIG. 11B illustrates example results of monadic adjusted shares 1150 associated with the tabulated results of FIG. 10A, 10B based on a logistic distribution. In the example of FIG. 11A, impacts on share estimates are shown when using a Gumbel distribution for data obtained in connection concept testing involving a shaving product 1005. In the example of FIG. 11B, impacts on share estimates are shown when using a logistic distribution for data obtained in connection concept testing involving a shaving product 1005. A greater adjusted of the share estimates is seen for results shown in FIG. 11B (e.g., using logistic distribution for data) when compared to FIG. 11A (e.g., using a Gumbel distribution for data). For example, as described in connection with FIG. 2, the monadic likelihood builder circuitry 205 can use an ordered logit that assumes that e is logistically distributed. In some examples, the monadic likelihood builder circuitry 205 can use a Gumbel distribution and the probability that a given concept i is shown and that a given box k (πᵢₖ) is selected. In some examples, the estimation engine circuitry 130 and/or the post-estimation calculation engine circuitry 135 can be used to perform a comparison of results obtained using logistic distribution for data versus Gumbel distribution for data.

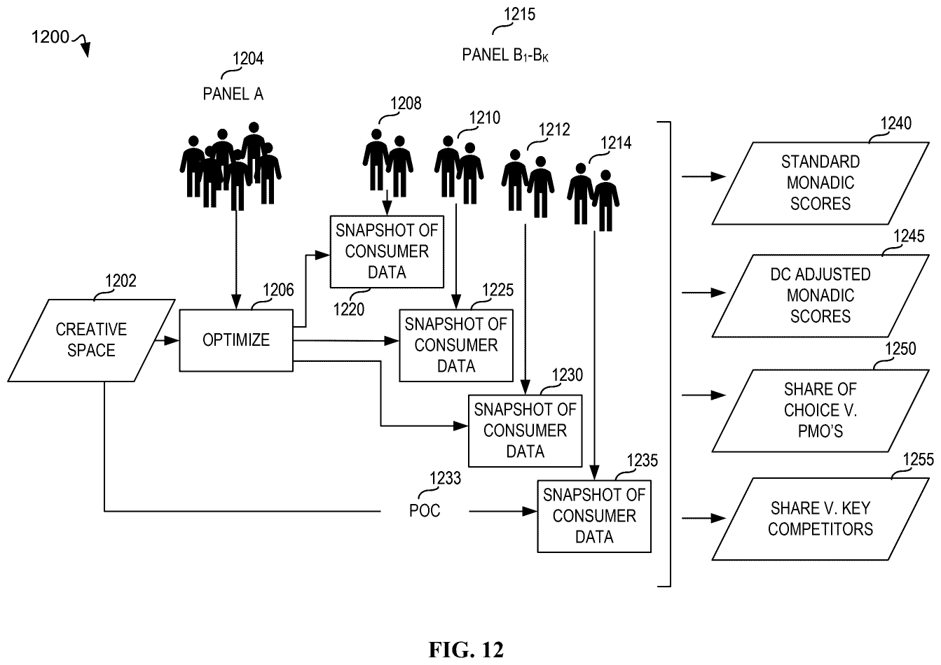

FIG. 12 illustrates an example experimental design 1200 for a survey analysis, including snapshots of consumer data that are used to identify output including standard monadic scores and discrete choice adjusted monadic scores. In the example of FIG. 12, a creative space 1202 input is optimized 1206 based on a panel of individuals (e.g., panel A) 1204. The panel 1204 can be subdivided into different groups of panelists (panels B₁−B_{K}) 1208, 1210, 1212, 1214, with snapshots of consumer data 1220, 1225, 1230, 1235 associated with each group of panelists 1208, 1210, 1212, 1214. In the example of FIG. 12, example point of concept (POC) 1233 testing can be performed for the purpose of validating that a product or idea is feasible to advance to the commercialization stage. Based on the experimental design 1200, outputs can be obtained for standard monadic scores data 1240, DC adjusted monadic scores data 1245, share of choice versus PMO data 1250, and share versus key competitors data 1255.

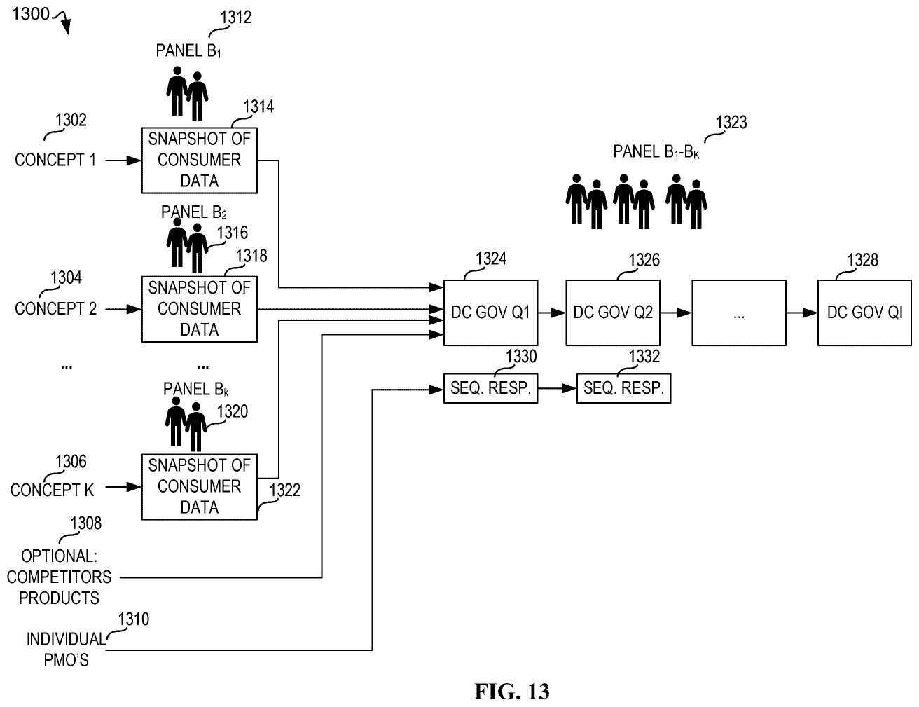

FIG. 13 illustrates an example experimental design 1300 for a survey analysis involving monadic and discrete choice testing, including the testing of different concepts using multiple panels. In the example of FIG. 13, concepts 1302, 1304, 1306 (e.g., concepts 1, 2, . . . , K) are tested, where each of the concepts 1302, 1304, 1306 includes a snapshot of consumer data 1314, 1318, 1320 associated with a particular set of panelists associated with a particular panel (e.g., panel B₁ 1312, panel B₂ 1304, panel B_{K} 1320, etc.). Using mixed monadic models, each concept is assumed to have a total utility that drives respondents' choices. As previously describe, total utility includes an observable component (e.g., a utility being estimated and reflected in a stimulus) and an unobservable component (e.g., factors not reflected in the stimulus, noise, etc.). In some examples, an assumption is made that monadic responses on the Likert scale are driven by the same total utility, allowing for a greater magnitude for the unobservable component to encompass scale limitations and scale use noise. A joint model can be used that includes multiple parameters to be estimated, including the observable utility for each concept (e.g., βᵢ, where I=1, . . . , k), utility cutoffs for the Likert scale (e.g., cⱼ, where j=1, . . . , 5), and the noise scaling parameter between two different tasks (K). In the example of FIG. 13, data for panel B₁−B_{K} can include discrete choice-based governing questions 1324, 1326, 1328 (e.g., Q1, Q2, . . . , QI), including sequential responses 1330, 1332 obtained using individual PMOs 1310. In some examples, competitor products 1308 can be incorporated into the analysis for additional assessment.

FIG. 14 is a block diagram of an example processor platform 1400 structured to execute and/or instantiate the machine readable instructions and/or operations of FIGS. 3,4 to implement the likelihood building engine circuitry 125 of FIG. 2. The processor platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1400 of the illustrated example includes processor circuitry 1412. The processor circuitry 1412 of the illustrated example is hardware. For example, the processor circuitry 1412 can be implemented by one or more integrated circuits, logic circuits, FPGAs microprocessors, CPUs, GPUs, DSPs, and/or microcontrollers from any desired family or manufacturer. The processor circuitry 1412 may be implemented by one or more semiconductor based (e.g., silicon based) devices. In this example, the processor circuitry 1412 implements the utility identifier circuitry 203, the monadic likelihood builder circuitry 205, the DC likelihood builder circuitry 210, and/or the combined likelihood builder circuitry 215.

The processor circuitry 1412 of the illustrated example includes a local memory 1413 (e.g., a cache, registers, etc.). The processor circuitry 1412 of the illustrated example is in communication with a main memory including a volatile memory 1414 and a non-volatile memory 1416 by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417.

The processor platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1422 are connected to the interface circuitry 1420. The input device(s) 1422 permit(s) a user to enter data and/or commands into the processor circuitry 1412. The input device(s) 1422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1424 are also connected to the interface circuitry 1420 of the illustrated example. The output devices 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1400 of the illustrated example also includes one or more mass storage devices 1428 to store software and/or data. Examples of such mass storage devices 1428 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1432, which may be implemented by the machine readable instructions of FIGS. 3,4, may be stored in the mass storage device 1428, in the volatile memory 1414, in the non-volatile memory 1416, and/or on a removable non-transitory computer readable storage medium such as a CD or DVD.

FIG. 15 is a block diagram of an example implementation of the processor circuitry 1412 of FIG. 14. In this example, the processor circuitry 1412 of FIG. 14 is implemented by a microprocessor 1500. For example, the microprocessor 1500 may implement multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowcharts of FIGS. 3, 4.

The cores 1502 may communicate by an example bus 1504. In some examples, the bus 1504 may implement a communication bus to effectuate communication associated with one(s) of the cores 1502. For example, the bus 1504 may implement at least one of an Inter-Integrated Circuit (I2C) bus, a Serial Peripheral Interface (SPI) bus, a PCI bus, or a PCIe bus. Additionally or alternatively, the bus 1504 may implement any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2_cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the L1 cache 1520, and an example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating point operations. In yet other examples, the AL circuitry 1516 may include first AL circuitry that performs integer based operations and second AL circuitry that performs floating point operations. In some examples, the AL circuitry 1516 may be referred to as an Arithmetic Logic Unit (ALU). The registers 1518 are semiconductor-based structures to store data and/or instructions such as results of one or more of the operations performed by the AL circuitry 1516 of the corresponding core 1502. For example, the registers 1518 may include vector register(s), SIMD register(s), general purpose register(s), flag register(s), segment register(s), machine specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure including distributed throughout the core 1502 to shorten access time. The bus 1520 may implement at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

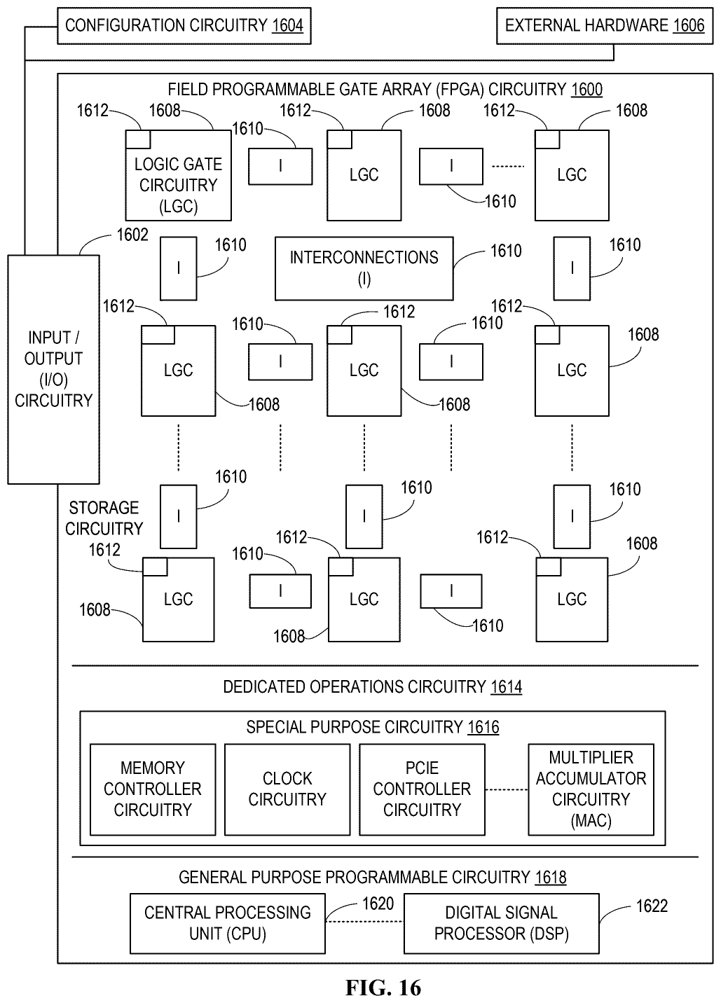

FIG. 16 is a block diagram of another example implementation of the processor circuitry 1412 of FIG. 14. In this example, the processor circuitry 1412 is implemented by FPGA circuitry 1600. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the machine readable instructions in hardware and, thus, can often execute the operations faster than they could be performed by a general purpose microprocessor executing the corresponding software.

More specifically, in contrast to the microprocessor 1500 of FIG. 15 described above (which is a general purpose device that may be programmed to execute some or all of the machine readable instructions represented by the flowcharts of FIGS. 3, 4 but whose interconnections and logic circuitry are fixed once fabricated), the FPGA circuitry 1600 of the example of FIG. 16 includes interconnections and logic circuitry that may be configured and/or interconnected in different ways after fabrication to instantiate, for example, some or all of the machine readable instructions represented by the flowcharts of FIGS. 3, 4. In particular, the FPGA 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the software represented by the flowcharts of FIGS. 3, 4. As such, the FPGA circuitry 1600 may be structured to effectively instantiate some or all of the machine readable instructions of the flowcharts of FIGS. 3, 4 as dedicated logic circuits to perform the operations corresponding to those software instructions in a dedicated manner analogous to an ASIC. Therefore, the FPGA circuitry 1600 may perform the operations corresponding to the some or all of the machine readable instructions of FIGS. 3, 4 faster than the general purpose microprocessor can execute the same.

In the example of FIG. 16, the FPGA circuitry 1600 is structured to be programmed (and/or reprogrammed one or more times) by an end user by a hardware description language (HDL) such as Verilog. The FPGA circuitry 1600 of FIG. 16, includes example input/output (I/O) circuitry 1602 to obtain and/or output data to/from example configuration circuitry 1604 and/or external hardware (e.g., external hardware circuitry) 1606. For example, the configuration circuitry 1604 may implement interface circuitry that may obtain machine readable instructions to configure the FPGA circuitry 1600, or portion(s) thereof. In some such examples, the configuration circuitry 1604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1606 may implement the microprocessor 1500 of FIG. 15. The FPGA circuitry 1600 also includes an array of example logic gate circuitry 1608, a plurality of example configurable interconnections 1610, and example storage circuitry 1612. The logic gate circuitry 1608 and interconnections 1610 are configurable to instantiate one or more operations that may correspond to at least some of the machine readable instructions of FIGS. 3, 4 and/or other desired operations. The logic gate circuitry 1608 shown in FIG. 16 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations. The logic gate circuitry 1608 may include other electrical structures such as look-up tables (LUTs), registers (e.g., flip-flops or latches), multiplexers, etc.

The interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example Dedicated Operations Circuitry 1614. In this example, the Dedicated Operations Circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the processor circuitry 1412 of FIG. 14, many other approaches are contemplated. For example, as mentioned above, modern FPGA circuitry may include an on-board CPU, such as one or more of the example CPU 1620 of FIG. 16. Therefore, the processor circuitry 1412 of FIG. 14 may additionally be implemented by combining the example microprocessor 1500 of FIG. 15 and the example FPGA circuitry 1600 of FIG. 16. In some such hybrid examples, a first portion of the machine readable instructions represented by the flowcharts of FIGS. 3, 4 may be executed by one or more of the cores 1502 of FIG. 15 and a second portion of the machine readable instructions represented by the flowcharts of FIGS. 3, 4 may be executed by the FPGA circuitry 1600 of FIG. 16.

In some examples, the processor circuitry 1412 of FIG. 14 may be in one or more packages. For example, the processor circuitry 1500 of FIG. 15 and/or the FPGA circuitry 1600 of FIG. 16 may be in one or more packages. In some examples, an XPU may be implemented by the processor circuitry 1412 of FIG. 14, which may be in one or more packages. For example, the XPU may include a CPU in one package, a DSP in another package, a GPU in yet another package, and an FPGA in still yet another package.

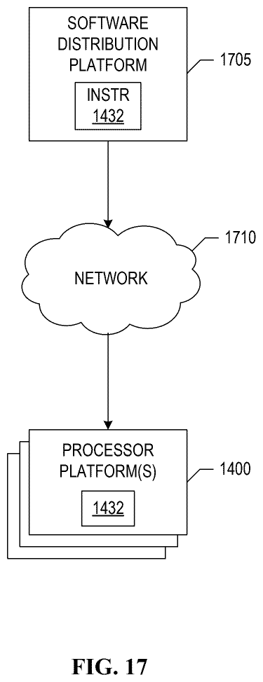

A block diagram illustrating an example software distribution platform 1705 to distribute software such as the example machine readable instructions 1432 of FIG. 14 to hardware devices owned and/or operated by third parties is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1432, which may correspond to the example machine readable instructions 300, 305 of FIGS. 3,4, as described above. The one or more servers of the example software distribution platform 1705 are in communication with a network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1432 from the software distribution platform 1705. For example, the software, which may correspond to the example machine readable instructions 300, 305 of FIGS. 3,4 may be downloaded to the example processor platform 1400, which is to execute the machine readable instructions 1432 to implement the likelihood building engine circuitry 125 of FIG. 2. In some example, one or more servers of the software distribution platform 1705 periodically offer, transmit, and/or force updates to the software (e.g., the example machine readable instructions 1432 of FIG. 14) to ensure improvements, patches, updates, etc., are distributed and applied to the software at the end user devices.

From the foregoing, it will be appreciated that methods and apparatus disclosed herein address the existing limitations of monadic testing and discrete choice testing by combining these methodologies. Examples disclosed herein can be used to reduce a signal-to-noise ratio (SNR) of monadic scores by identifying utility value(s) associated with a plurality of products, identifying a discrete choice probability of selection of a given product based on the utility values, and generating monadic scale question(s) for a given product (e.g., one monadic scale question per product, corresponding to one choice objective). In the examples disclosed herein, the signal-to-noise ratio of the monadic probability is reduced by joining the discrete choice probability of selecting a given product with the monadic probability of selecting the given product based on a scaling factor indicative of a type of correlation between the discrete choice probability and the monadic probability.

Example methods and apparatus to reduce signal-to-noise ratio (SNR) of monadic scores are disclosed herein. Further examples and combinations thereof include the following:

Example 1 includes an apparatus to reduce a signal-to-noise ratio (SNR) of monadic scores, the apparatus comprising memory, machine readable instructions, and processor circuitry to execute the machine readable instructions to at least identify a discrete choice probability of selection corresponding to a first product, generate a scale question corresponding to the first product, calculate a monadic probability corresponding to the first product based on the scale question for the first product, and reduce the SNR of the monadic probability by joining the discrete choice probability of selection of the first product with the monadic probability of selecting the first product.

Example 2 includes the apparatus of example 1, wherein the processor circuitry is to reduce the SNR of the monadic probability using a scaling factor indicative of a type of correlation between the discrete choice probability and the monadic probability, the correlation a positive correlation or a negative correlation.

Example 3 includes the apparatus of example 1, wherein the processor circuitry is to identify a utility value associated with the first product.

Example 4 includes the apparatus of example 3, wherein the processor circuitry is to identify the discrete choice probability or the monadic probability of the first product using the utility value.

Example 5 includes the apparatus of example 1, wherein the processor circuitry is to identify the monadic probability using at least one of an aggregate model, a latent class model, or a hierarchical Bayesian model.

Example 6 includes the apparatus of example 5, wherein monadic experiment data and discrete choice experiment data is shared among individuals when using the hierarchical Bayesian model.

Example 7 includes the apparatus of example 1, wherein the monadic probability is based on a monadic question on a K-point Lickert scale.

Example 8 includes the apparatus of example 1, wherein the monadic probability is determined using at least one of a Gumbel distribution or a logistic distribution.

Example 9 includes a computer implemented method to reduce a signal-to-noise ratio (SNR) of monadic scores, the method comprising identifying a discrete choice probability of selection of a first product, generating a scale question for the first product, calculating a monadic probability corresponding to the first product based on the scale question for the first product, and reducing the SNR of the monadic probability by joining the discrete choice probability of selection of the first product with the monadic probability of selecting the first product.

Example 10 includes the computer implemented method of example 9, wherein reducing the SNR of the monadic probability includes using a scaling factor indicative of a type of correlation between the discrete choice probability and the monadic probability, the correlation a positive correlation or a negative correlation.

Example 11 includes the computer implemented method of example 9, further including identifying a utility value associated with the first product.

Example 12 includes the computer implemented method of example 11, further including identifying the discrete choice probability or the monadic probability of the first product using the utility value.

Example 13 includes the computer implemented method of example 9, further including identifying the monadic probability using at least one of an aggregate model, a latent class model, or a hierarchical Bayesian model.

Example 14 includes the computer implemented method of example 13, wherein monadic experiment data and discrete choice experiment data is shared among individuals when using the hierarchical Bayesian model.

Example 15 includes the computer implemented method of example 9, wherein the monadic probability is based on a monadic question on a K-point Lickert scale.

Example 16 includes the computer implemented method of example 9, wherein the monadic probability is determined using at least one of a Gumbel distribution or a logistic distribution.

Example 17 includes a non-transitory computer readable storage medium comprising instructions that, when executed, cause processor circuitry to at least identify a discrete choice probability of selection of a first product, generate a scale question corresponding to the first product, calculate a monadic probability corresponding to the first product based on the scale question for the first product, and reduce the SNR of the monadic probability by joining the discrete choice probability of selection of the first product with the monadic probability of selecting the first product.

Example 18 includes the non-transitory computer readable storage medium of example 17, wherein reducing the SNR of the monadic probability includes using a scaling factor indicative of a type of correlation between the discrete choice probability and the monadic probability, the correlation a positive correlation or a negative correlation.

Example 19 includes the non-transitory computer readable storage medium of example 17, wherein the instructions, when executed, cause the processor circuitry to identify a utility value associated with the first product.

Example 20 includes the non-transitory computer readable storage medium of example 19, wherein the instructions, when executed, cause the processor circuitry to identify the discrete choice probability or the monadic probability of the first product using the utility value.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1.-20. (canceled)

21. An apparatus, the apparatus comprising:
interface circuitry;
machine readable instructions; and
at least one processor circuit to be programmed by the machine readable instructions to:
generate a graphical user interface (GUI) to present market-available products on a display device;
generate choice sets of the market-available products, the choice sets associated with a candidate product;
retrieve, from the GUI, selection information corresponding to (a) the market-available products and (b) the candidate product;
calculate a discrete choice probability of selection based on the selection information corresponding to a first one of the market-available products by:
applying a Gumbel distribution to a deviation between (1) an observed outcome and (2) a true outcome;
associating one or more random variables, with an ordered logit model, to a binomial random variable; and
modifying a data structure of a memory with distributed ones of the one or more random variables based on the Gumbel distribution, the one or more random variables distributed in the data structure based on (a) a probability density function and (b) a cumulative distribution function;
calculate a monadic probability corresponding to the first one of the market-available products based on the Gumbel distribution, the discrete choice probability of selection and the monadic probability associated with a homogenous population of panelists;
generate a combined likelihood of selection by joining the discrete choice probability of selection of the first one of the market-available products with the monadic probability of selecting the first one of the market-available products;
generate a signal-to-noise ratio (SNR) based on data inconsistencies corresponding to a likelihood of product selection associated with the combined likelihood of product selection; and
cause one or more products to be released for public access by adjusting to a customer probability of purchasing the first one of the products.

22. The apparatus of claim 21, wherein one or more of the at least one processor circuit is to calculate the monadic probability corresponding to the first one of the products based on the Gumbel distribution and a cut-off point error.

23. The apparatus of claim 22, wherein the cut-off point error is associated with an average item utility value distribution.

24. The apparatus of claim 21, wherein one or more of the at least one processor circuit is to generate a combined likelihood of product selection based on at least one of a distribution function of utility or a probability of item selection.

25. The apparatus of claim 24, wherein one or more of the at least one processor circuit is to automatically select at least one of the distribution function of utility or the probability of item selection based on at least one of a K-point Likert scale or a discrete choice-based selection, respectively.

26. The apparatus of claim 21, wherein one or more of the at least one processor circuit is to reduce the SNR of the monadic probability using a scaling factor indicative of a type of correlation between the discrete choice probability and the monadic probability, the correlation being a positive correlation or a negative correlation.

27. The apparatus of claim 21, wherein one or more of the at least one processor circuit is to perform a post-estimation analysis of data inconsistencies on an individual level, a group level, or an aggregate level.

28. The apparatus of claim 21, wherein the choice sets are associated with a future product or a current in-market product.

29. The apparatus of claim 21, wherein the products are released for public access by adjusting a volume of the one or more products a manufacturer sells in a post-product launch.

30. The apparatus of claim 21, wherein the observed outcome corresponds to an expected utility of a selected product and the true outcome corresponds to an actual utility of the selected product.

31. The apparatus of claim 21, the observed outcome corresponding to an expected utility of a selected product and the true outcome corresponding to an actual utility of the selected product.

32. A computer implemented method to reduce a signal-to-noise ratio (SNR) of monadic scores, the method comprising:
generating a graphical user interface (GUI) to present market-available products on a display device;
generating choice sets of the market-available products, the choice sets associated with a candidate product;
retrieving, from the GUI, selection information corresponding to (a) the market-available products and (b) the candidate product;
calculating a discrete choice probability of selection based on the selection information corresponding to a first one of the market-available products by:
applying a Gumbel distribution to a deviation between (a) an observed outcome and (b) a true outcome;
associating one or more random variables, with an ordered logit model, to a binomial random variable; and
modifying a data structure of a memory with distributed ones of the one or more random variables based on the Gumbel distribution, the one or more random variables distributed in the data structure based on (a) a probability density function and (b) a cumulative distribution function;
calculating a monadic probability corresponding to the first one of the market-available products based on the Gumbel distribution, the discrete choice probability of selection and the monadic probability associated with a homogenous population of panelists;
generating a combined likelihood of selection by joining the discrete choice probability of selection of the first one of the market-available products with the monadic probability of selecting the first one of the market-available products;
generating a signal-to-noise ratio based on data inconsistencies corresponding to a likelihood of product selection associated with the combined likelihood of product selection; and
causing one or more products to be released for public access by adjusting to a customer probability of purchasing the first one of the products.

33. The computer implemented method of claim 32, further including calculating the monadic probability corresponding to the first one of the products based on the Gumbel distribution and a cut-off point error.

34. The computer implemented method of claim 33, wherein the cut-off point error is associated with an average item utility value distribution.

35. The computer implemented method of claim 32, further including generating a combined likelihood of product selection based on at least one of a distribution function of utility or a probability of item selection.

36. The computer implemented method of claim 32, further including automatically selecting at least one of a distribution function of utility or a probability of item selection based on at least one of a K-point Likert scale or a discrete choice-based selection, respectively.

37. The computer implemented method of claim 32, further including reducing the SNR of the monadic probability using a scaling factor indicative of a type of correlation between the discrete choice probability and the monadic probability, the correlation being a positive correlation or a negative correlation.

38. At least one non-transitory machine-readable medium comprising machine-readable instructions to cause at least one processor circuit to at least:
generate a graphical user interface (GUI) to present market-available products on a display device;
generate choice sets of the market-available products, the choice sets associated with a candidate product;
retrieve, from the GUI, selection information corresponding to (a) the market-available products and (b) the candidate product;
calculate a discrete choice probability of selection based on the selection information corresponding to a first one of the market-available products by:
applying a Gumbel distribution to a deviation between (1) an observed outcome and (2) a true outcome;
associating one or more random variables, with an ordered logit model, to a binomial random variable; and
modifying a data structure of a memory with distributed ones of the one or more random variables based on the Gumbel distribution, the one or more random variables distributed in the data structure based on (a) a probability density function and (b) a cumulative distribution function;
calculate a monadic probability corresponding to the first one of the market-available products based on the Gumbel distribution, the discrete choice probability of selection and the monadic probability associated with a homogenous population of panelists;
generate a combined likelihood of selection by joining the discrete choice probability of selection of the first one of the market-available products with the monadic probability of selecting the first one of the market-available products;
generate a signal-to-noise ratio based on data inconsistencies corresponding to a likelihood of product selection associated with the combined likelihood of product selection; and
cause one or more products to be released for public access by adjusting to a customer probability of purchasing the first one of the products.

39. The at least one non-transitory machine-readable medium of claim 38, wherein the machine-readable instructions are to cause one or more of the at least one processor circuit to calculate the monadic probability corresponding to the first one of the products based on the Gumbel distribution and a cut-off point error.

40. The at least one non-transitory machine-readable medium of claim 39, wherein the cut-off point error is associated with an average item utility value distribution.
